(19) United States
(12) Patent Application Publication
(10) Pub. No.: US 2026/0365790 A1
(43) Pub. Date: Nov. 19, 2026

(54) Humidity Curable Two-Component System Comprising Accelerator

(71) Applicant: Zephyros, Inc., Romeo, MI (US)

(72) Inventors: Laurence Grau, Molsheim Cedex (FR); Dietmar Golombowski, Molsheim Cedex (FR)

(21) Appl. No.: 19/491,649

(22) PCT Filed: Jun. 12, 2024
(86) PCT No.: PCT/EP2024/066272

§ 371 Date: Dec. 9, 2025

(30) Foreign Application Priority Data
Jun. 13, 2023 (EP) 23178839.9

(51) Int. Cl. C08G 65/336; C08K 3/04; C08K 3/34; C08K 3/38; C09J 11/04; C09J 11/06; C09J 171/12

(52) U.S. Cl. CPC C08G 65/336; C08K 3/042; C08K 3/34; C08K 3/38; C09J 11/04; C09J 11/06; C09J 171/12; C08K 2003/385

(57) ABSTRACT

The invention relates to a fast curable two-component system based upon humidity-curable prepolymers, preferably silyl-modified prepolymers (SMP). Upon mixing the first component with the second component, the resultant mixture cures in a relatively short period of time. The curable two-component system is useful as adhesive or sealant and can be used by means of standard equipment for applying two-component systems.

Priority is claimed of European patent application no. 23 178 839.9 that was filed on Jun. 13, 2023.

The invention relates to a fast curable two-component system based upon humidity-curable prepolymers, preferably silyl-modified prepolymers (SMP). Upon mixing the first component with the second component, the resultant mixture cures in a relatively short period of time. The curable two-component system is useful as adhesive or sealant and can be used by means of standard equipment for applying two-component systems.

Adhesives and sealants that are based upon silyl-modified prepolymers have been known as typical pretreatment-free solutions. Due to intensifying regulatory restrictions, the silane-terminated prepolymer chemistry focuses on environmentally friendly solutions. Adhesives and sealants that are based upon silyl-modified prepolymers are known from e.g. EP 3 546 541 A1, CN 109 880 570 A, U.S. Pat. No. 6,762,242 B1, US 2007 0237912 A1, US 2007 0088110 A1, US 2010 0197855 A1, US 2011 0232825 A1, US 2011 0308730 A1, US 2012 0225983 A1, US 2012 0055105 A1, US 2014 0228515 A1, WO 2014 073593 A1, WO 2015/185642 A1, WO 2017 142714 A1, WO 2017 189057 A1, US 2018 0134932 A1, WO 2018 074925 A1, US 2019 0048190 A1, US 2019 0144717 A1, US 2019 0233335 A1, and WO 2022 122782 A1.

Adhesives and sealants based upon silyl-modified prepolymers are typically one-component adhesives. These one-component systems are typically water-diffusion controlled slow reacting products. They do not contain humidity themselves but absorb water from the environment, e.g. air humidity. Curing times are therefore relatively long, e.g. 12 to 24 hours.

Fast curing can be achieved by providing adhesives and sealants based upon silyl-modified prepolymers in form of two-component systems wherein one of the two components is free of water and comprises the silyl-modified prepolymer, whereas the other of the two components is an accelerator paste (booster system) typically comprising water in order to eliminate slow environmental humidity dependency. However, the accelerator paste (booster system) has typically a comparatively small volume that prior to application needs to be mixed with a comparatively large volume of the other component containing the silyl-modified prepolymer. In consequence, such fast curing two-component systems require mixing ratios of the two components with one another of typically 40:1 to 100:1.

However, such two-component systems have several disadvantages due to the high mixing ratio. The dosing needs to be very specific and accurate to deal with the big volumetric dosing difference between main component and accelerator paste. Such two-component systems cannot be applied by means of commonly used standard dosing equipment that is customized for 1:1 or 2:1 mixing ratio. Only special dispensing and mixing tools can be used that have been available on the marked, but were not well accepted due to the very high costs and limitations in view of multi-sourcing for different adhesive system suppliers.

When such two-component systems are formulated to allow for a lower mixing ratio of e.g. 1:1 or 2:1, the volume of the accelerator paste (booster system) is increased by adding plasticizer or binder, which, however, compromise the mechanical properties of the cured sealant or adhesive.

WO 2020 067877 A1 relates to a silyl modified terminated polymer used in a composition for use as a sealant or adhesive, and especially in combination with a specific booster comprising additives.

Furthermore, adhesive or sealant compositions need to satisfy certain performance properties such as high strength paired with high elongation, but also durable adhesion under various climate conditions. Climate cycle tests have been developed by original equipment manufacturers (OEM) involving sample testing under harsh conditions such as 70 °C cataplasm with freezing step. Modern adhesive or sealant compositions need to pass such tests.

Conventional adhesive or sealant compositions are often based upon polyurethanes containing reactive isocyanate groups such as toluene diisocyanate (TDI), methylene bisphenyl diisocyanate (MDI), hexamethylene diisocyanate (HDI), naphthalene diisocyanate (NDI), and diisocyanate dicyclohexyl urethane. Such isocyanate products are hazardous as they are powerful irritants to the mucous membranes of the eyes, gastrointestinal and respiratory tracts. Health effects of isocyanate exposure include irritation of skin and mucous membranes, chest tightness, and difficult breathing. Isocyanates include compounds classified as potential human carcinogens and known to cause cancer in animals. The main effects of hazardous exposures are occupational asthma and other lung problems, as well as irritation of the eyes, nose, throat, and skin.

Further, conventional adhesive or sealant compositions often contain phthalates as plasticizers. Phthalate plasticizers are not chemically bound in the cured adhesive compositions, but can leach, migrate or evaporate into indoor air. Building materials such as vinyl flooring and other consumer products containing phthalates can result in human exposure through direct contact and use, indirectly through leaching into other products, or general environmental contamination. Humans are exposed through ingestion, inhalation, and dermal exposure during their whole lifetime. Many phthalates are hormone-disrupting chemicals that interfere with the production of testosterone. Pre-natal exposure to certain phthalates causes common adverse effects on male reproductive development in animals, causing what is known as “phthalate syndrome”, which has many similarities to “testicular dysgenesis syndrome” in humans.

There is thus a demand for adhesive or sealant compositions that neither contain isocyanates nor phthalates. While certain adhesive compositions based upon silicone polymers, e.g. polysiloxanes, are also well known sealants, durable elastic adhesive compositions that achieve equal performance like compositions based upon polyurethane prepolymers have not been available for decades.

Furthermore, conventional adhesive or sealant compositions often require a pretreatment of substrate surfaces before the compositions may be applied thereto in order to provide satisfactory bonding. Such pretreatment, however, is time-consuming and laborious and there is a demand for adhesive or sealant compositions that do not require such pretreatment but nonetheless provide excellent adherence to surfaces of various materials including glass, plastics, and metals.

Moreover, after a certain while of use or e.g. after an accident, the adhesive bonds or sealings need to be repaired are renewed. However, conventional adhesive or sealant compositions are often difficult the be removed or repaired, especially when they are bonded to polyurethane substrates. It would thus be desirable to provide adhesive or sealant compositions that facilitate renewal and repair.

It is an object of the invention to provide adhesive or sealant compositions that overcome the drawbacks of the prior art and that satisfy one or more of the above needs.

This object has been achieved by the subject-matter of the patent claims.

It has been surprisingly found that fast curing two-component systems can be provided at mixing ratios of about 1:1 or 2:1 (v/v) that do not need to contain significant amounts of fillers, binders, plasticizers or other inert constituents in the accelerator paste (booster) so that they do not compromise the mechanical properties of the cured compositions (adhesives and/or sealants).

In particular, it has been surprisingly found that silyl-modified prepolymers can be stabilized even in the presence of water without premature curing. According to the prior art, moisture curable prepolymer (e.g. silyl-modified prepolymer) on the one hand and accelerator (e.g. water) on the other hand must strictly be separated from one another during storage in order to prevent premature viscosity build-up and curing. In contrast, the invention provides storage-stable two-component systems wherein during storage moisture curable prepolymer (e.g. silyl-modified prepolymer) is in direct contact with water.

In consequence, the total amount of moisture curable prepolymer (e.g. silyl-modified prepolymer) may be distributed over the first component and the second component of the curable two-component system. The volume of the first component and the volume of the second component may thus be adjusted to ratios of e.g. about 1:1 or 2:1 (v/v) without the need of adding high amounts of fillers, binders, plasticizers or other inert constituents. When the two components are mixed with one another, the entire mixture will start curing.

Without wishing to be bound to any scientific theory, it appears that moisture curable prepolymers, especially silyl-modified prepolymers, can be stabilized in the presence of water by certain additives at elevated pH values. When the first component, which contains such a stabilized silyl-modified prepolymer in presence of water at an elevated pH value, is mixed with the second component, which preferably contains curing catalyst, the pH value of the resultant mixture is lowered thereby diminishing the stabilization of the silyl-modified prepolymer so that fast curing is induced. Curing is preferably but does not necessarily need to be promoted by the presence of a curing catalyst in the second component. In certain embodiments, the shift of the pH value alone may suffice for inducing fast curing even in the absence of a curing catalyst. If the resulting pH value is either quite low or quite high the curing mechanism will be acid catalyzed or base catalyzed so that a curing catalyst may not be needed. If the resulting pH value is closer to neutral, a curing catalyst is typically needed in order to achieve fast curing. It is a matter of resulting pH after mixing and pH before mixing if a catalyst will be needed or not. It further appears that the amount of curing catalyst, if present, can also play a role in overcoming the stabilizing effect so that fast curing is induced.

During storage, i.e. prior to mixing with the second component that preferably contains curing catalyst (and typically no water), the mixture of silyl-modified prepolymer and water can be stabilized by an elevated pH value. Additives that contribute to the stabilization (i.e. avoidance of premature curing) include Na⁺-ions, K⁺-ions, metal hydroxides (such as Al(OH)₃), metal oxides (such as Al₂O₃, MgO, and ZnO), SiO₂, natural or synthetic minerals that bear or form upon contact with water Si—OH groups (including those minerals that comprise Al₂O₃, MgO, ZnO, SiO₂), carbon black, graphene, graphene oxide, organo-modified graphene, nitrides (such as AlN and BN), and graphite.

It appears that all of these additives can interact with silanol-groups of at least partially hydrolyzed silyl-modified prepolymer and stabilize them, e.g. by electrostatic repulsion at a pH-specific condition, influenced by the electrostatic nature of the functionalized silane and silyl-modified prepolymer, respectively.

It appears that certain fillers like silicates, in particular talc, MgO, ZnO, Al₂O₃ and graphene oxide are capable of interacting with silanol groups and complexing silanol groups. Also, Na⁺-ions, K⁺-ions, etc. stabilize the silyl-modified prepolymer in the presence of water. It seems that metal ions and metal oxides form stable silanol complexes and suppress the condensation of the active silanol species in basic environment.

Depending on the pH value, the amount of ions that are needed in order to provide a satisfactory stabilizing effect will vary. It appears that the higher the pH value, the lower the amount of ions that are needed for stabilization.

It has been surprisingly found that pH value and content of donors for Na⁺ ions (Na-donors) are relevant for the stability of a two-component system, in particular to stabilize the humidity-curable prepolymer, preferably silyl-modified prepolymer, in the presence of water. It has been found that a pH value of 5 to 10, preferably of 7 to 10 can stabilize the two-component system. Further, it has been found that a content of donors for Na⁺ ions (Na-donors), preferably Na₂O, NaOH, or a mixture thereof, of at least about 0.03 wt.-%, preferably at least about 0.04 wt.-% can stabilize the two-component system. The combination of a pH value of 5 to 10, preferably of 7 to 10, and a content of donors for Na⁺ ions (Na-donors), preferably Na₂O, NaOH, or a mixture thereof, of at least about 0.03 wt.-%, preferably at least about 0.04 wt.-%, is particularly useful to stabilize the two-component system.

It has been surprisingly found that various properties of a two-component system can be manipulated by the combination of pH value, presence and amount of Na⁺-ions and/or K⁺-ions, presence and amount of metal oxides that are capable of forming stable silanol complexes, presence and amount of metal catalysts, and presence and amount of amine catalysts. The properties that can be manipulated include but are not limited to curing kinetics, latency, open time, strength build-up and shelf-life.

The invention allows mixing ratios down to 1:1 (v/v) without compromising mechanical properties. Water as curative and silyl-terminated prepolymers of any backbone chemistry can be combined with suitable storage stability, but without any dilution by fillers, binders, plasticizers or other inert materials that would otherwise cause compromises on mechanical properties. Further, the pairing component containing stabilized silyl-modified prepolymer and water (first component) can be combined with different silyl-modified prepolymer components (second component) to easily change material properties of the resultant mixtures.

The invention allows to combine moisture curable prepolymer and water in a very stable way. This stabilized formulation (first component) will not gain viscosity or cure until it is mixed with the other component (second component) of the two-component system that preferably contains curing catalyst. Only when mixed (e.g. statically or dynamically), the shift of the pH value and/or the curing catalyst of the other component (second component) will trigger curing to form a bond and/or seal.

The moisture stabilization also facilitates the manufacturing process of the two-component system according to the invention, because laborious steps such as drying of fillers and other components can be omitted. The presence of water does not need to be minimized or fully eliminated.

A first aspect of the invention relates to a curable two-component system, preferably an adhesive and/or a sealant, comprising or essentially consisting of
(a) a first component comprising
   one or more humidity-curable prepolymers;
   optionally, water; and
   one or more of the following:
   one or more basic inorganic fillers or anhydrides thereof;
   a graphene constituent;
   a natural or synthetic silicate;
   carbon black;
   expandable graphite;
   wherein the first component is free of curing catalyst; and
(b) a second component optionally, but preferably, comprising one or more curing catalysts;
preferably wherein the first component comprises
   one or more humidity-curable prepolymers;
   one or more basic inorganic fillers or anhydrides thereof; and
   optionally, but preferably, water.

Preferably, the curable two-component system according to the invention comprises or essentially consists of
(a) a first component comprising
   one or more humidity-curable prepolymers;
   one or more basic inorganic fillers or anhydrides thereof;
   optionally, water;
   wherein the first component is free of curing catalyst; and
(b) a second component optionally, but preferably, comprising one or more curing catalysts.

For the purpose of the specification, unless expressly stated otherwise, percentages are percent by weight and ppm are weight-related. Unless expressly stated otherwise, any norms such as EN ISO, ASTM and the like are in the official version that is valid on Jan. 1, 2023.

The expression “essentially consists of” means a content of at least about 95 wt.-%, preferably at least about 99 wt.-%, relative to the total weight of the component to which the definition refers.

The system according to the invention is a two-component system comprising a first component and a second component. The first component is spatially separated from the second component, e.g. in separate cartridges or other suitable containers. Preferably, the two-component system essentially consists of the first component and the second component. It is contemplated, however, that besides the first component and the second component the two-component system according to the invention may comprise one or more additional components and may then be regarded as a multi-components system.

The two-component system according to the invention is preferably a ready-to use composition that already contains all ingredients that are needed for the desired purpose. In particular, prior to use, the curable two-component system according to the invention does preferably not require any addition of further additives; it merely requires mixing of the first component and the second component with one another under ambient conditions, e.g. at room temperature (23 °C).

The two-component system according to the invention is curable, i.e. is capable of autonomously undergoing a curing reaction, typically by cross-linking, after mixing the first component with the second component with one another.

The composition is useful inter alia for bonding and joining similar and dissimilar substrates.

For the purpose of the specification, a “prepolymer” (polymer precursor) is a monomer or system of monomers that have been reacted to an intermediate molecular mass state. This material is capable of further polymerization by reactive groups to a fully cured high molecular weight state. Prepolymers encompass mixtures of reactive polymers with unreacted monomers. The prepolymer is humidity-curable, i.e. upon contact with humidity undergoes spontaneous curing, optionally also involving other ingredients that are contained in the composition such as curing agents.

In preferred embodiments of the curable two-component system according to the invention, the one or more humidity-curable prepolymers comprise or essentially consist of one or more silyl-modified prepolymers.

The curable two-component system according to the invention may comprise a single humidity-curable prepolymer or a mixture of two or more humidity-curable prepolymers in both components. In the case of the presence of two or more humidity-curable prepolymers, all weights and percentages refer to the total weight of all humidity-curable prepolymers that are contained in the curable two-component system.

Preferably, the silyl-modified prepolymer comprises a polymeric backbone and one or more hydrolyzable silyl groups.

It is contemplated that at least a portion of the hydrolyzable silyl groups may be present in hydrolyzed form. Thus, for example, when the hydrolyzable silyl group is a methoxysilyl group, it may at least partially be hydrolyzed to methanol and a silanol group (R₃Si—OCH₃+H₂O->R₃Si-OH+HOCH₃).

The silyl-modified or functional prepolymer can be a silyl-modified polyether or other type of monomer combinations to form a prepolymer formulation. This includes PU-typical prepolymers being silane terminated with any type of functionalized silane.

This silyl-modified prepolymer can be used for all components of a two- or more-component adhesive system. Both components may also contain fillers like calcium carbonate, China clay, bentonite, metal oxides and their hydroxides like aluminum trihydrate, carbon black, layered silicates, and other natural or synthetic minerals.

Examples of silyl-modified polymers include but are not limited to silyl-modified polyethers and copolyethers, silyl-modified polyisobutylenes (SMPIB), silyl-modified polyacrylates and copolyacrylates (SMA) and silyl-modified polyurethanes (SPUR, PUH).

Preferably the silyl-modified prepolymer has a non-silicone backbone, more preferably a polyether backbone. For example, the silyl-modified prepolymer can be dimethoxysilyl-modified polymer, trimethoxysilyl-modified polymer, or triethoxysilyl-modified polymer. For example, the silyl-modified prepolymer can be a silyl-modified polyether or copolyether.

In this embodiment the silyl-modified prepolymers can contain heteroatoms like N, O, S or other functional groups urethane, between the monomer units, to provide different properties targeting as different applications and functions.

For the purpose of the specification, a prepolymer (polymer precursor) is a monomer or system of monomers that have been reacted to an intermediate molecular mass state. This material is capable of further polymerization by reactive groups to a fully cured high molecular weight state. Prepolymers encompass mixtures of reactive polymers with unreacted monomers. The prepolymer is humidity-curable, i.e. upon contact with humidity undergoes spontaneous curing, optionally also involving other ingredients that are contained in the composition such as curing agents.

Humidity-curable prepolymers are known to the skilled person and commercially available.

In preferred embodiments of the curable two-component system according to the invention, the humidity-curable prepolymer is a silyl-modified prepolymer. As the preferred silyl-modified polymer is a curable prepolymer, it is a reactive prepolymer (reactive silyl-modified prepolymer). Silyl-modified prepolymers (SMP, silane-modified polymers, modified-silane polymers, MS polymers, silane-terminated polymers, etc.) are known to the skilled person and commercially available. For details on silyl-modified prepolymers, it can be referred to e.g. S. M. Guillaume, Advances in the synthesis of silyl-modified polymers (SMPs), Polym. Chem., 2018, 9, 1911-1926; A. Pizzi et al., Handbook of Adhesive Technology, CRC Press, 3rd edition, 2018. Examples of silyl-modified polymers include but are not limited to silyl-modified polyethers and copolyethers, silyl-modified polyisobutylenes (SMPIB), silyl-modified polyacrylates and copolyacrylates (SMA) and silyl-modified polyurethanes (SPUR, PUH).

Preferably the silyl-modified prepolymer has a non-silicone backbone, more preferably this silyl-modified prepolymer has a polyether backbone. For example, the silyl-modified prepolymer can be dimethoxysilyl-modified polymer, trimethoxysilyl-modified polymer, or triethoxysilyl-modified polymer. For example, the silyl-modified prepolymer can be a silyl-modified polyether or copolyether.

Preferred silyl-modified prepolymers according to the invention are selected from
silyl-modified polyethers or copolyethers, preferably silyl-terminated polyethers or copolyethers, e.g. silyl-modified polyethylene glycols, silyl-modified polypropylene glycols, and the like;
silyl-modified polyurethanes, preferably silyl-terminated polyurethanes; and
silyl-modified acrylates, preferably silyl-terminated acrylates.

In preferred embodiments, the silyl-modified prepolymer
has two ends and is terminated with one or more hydrolyzable silyl groups on one end (semi-telechelic) or on both ends (telechelic); preferably on two ends; and/or
has side chains carrying one or more hydrolyzable silyl groups.

Preferably, hydrolysis of at least one of the one or more hydrolyzable silyl groups leads to the formation of a silanol group.

Preferably, the condensation of the silanol group with another silanol group or with a hydrolyzable silyl group leads to the formation of a siloxane group.

Preferably, the one or more hydrolyzable silyl groups independently of one another are
monopodal silyl groups of general formula (I)

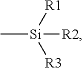

or
dipodal silyl groups of general formula (II)

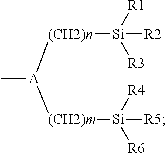

wherein in each case R1, R2, R3, R4, R5 and R6 independently of one another are selected from
substituents forming silicon-carbon bonds selected from the group consisting of —C₁₋₁₂-alkyl, —C₁₋₆-alkylene-O—C₁₋₆-alkyl, —C₆₋₁₀-aryl, —C₁₋₆-alkylene-C₆₋₁₀-aryl, —C₁₋₆-alkylene-O—C₆₋₁₀-aryl;
substituents forming silicon-oxygen bonds selected from the group consisting of —O—C₁₋₁₂-alkyl, —OC₁₋₆-alkylene-O—C₁₋₆-alkyl, —O—C₆₋₁₀-aryl, —O—C₁₋₆-alkylene-C₆₋₁₀-aryl, —O—C₁₋₆-alkylene-O—C₆₋₁₀-aryl, —OC(═O)—C₁₋₁₂-alkyl, —OC(═O)—C₁₋₆-alkylene-O—C₁₋₆-alkyl, —OC(═O)—C₆₋₁₀-aryl, —OC(═O)—C₁₋₆-alkylene-C₆₋₁₀-aryl, —OC(═O)—C₁₋₆-alkylene-O—C₆₋₁₀-aryl;
substituents forming silicon-nitrogen bonds selected from the group consisting of —NH—C₁₋₁₂-alkyl, —NH—C₁₋₆-alkylene-O—C₁₋₆-alkyl, —NH—C₆₋₁₀-aryl, —NH—C₁₋₆-alkylene-C₆₋₁₀-aryl, —NH—C₁₋₆-alkylene-OC₆₋₁₀-aryl;
substituents forming silicon-halogen bonds selected from the group consisting of —F, —Cl, —Br, —I;
   with the proviso that at least about one of R1, R2 and R3, and at least about one of R4, R5 and R6 is not a substituent forming silicon-carbon bonds; preferably with the proviso that at least about one of R1, R2 and R3, and at least about one of R4, R5 and R6 is selected from substituents forming silicon-oxygen bonds;
   A represents —N< or —CH<; and
   m and n independently of one another are an integer within the range of from 0 to 18, preferably 1, 2, 3 or 4.

Preferably, R1, R2, R3, R4, R5 and R6 independently of one another represent —CH₃, —CH₂CH₃, —CH₂CH₂CH₃, —CH(CH₃)₂, —CH₂CH₂CH₂CH₃, —CH(CH₃)CH₂CH₃, —CH₂CH(CH₃)₂, —C(CH₃)₃, —CH₂CH₂OCH₃, —CH₂CH₂OCH₂CH₃, —CH₂CH₂CH₂OCH₃, —CH₂CH₂CH₂OCH₂CH₃, —OCH₃, —OCH₂CH₃, —OCH₂CH₂CH₃, —OCH(CH₃)₂, —OCH₂CH₂CH₂CH₃, —OCH(CH₃)CH₂CH₃, —OCH₂CH(CH₃)₂, —OC(CH₃)₃, —OCH₂CH₂OCH₃, —OCH₂CH₂OCH₂CH₃, —OCH₂CH₂CH₂OCH₃, or —OCH₂CH₂CH₂OCH₂CH₃.

Preferably, the one or more hydrolyzable silyl groups independently of one another are selected from the group consisting of monomethoxy silyl groups, monoethoxy silyl groups, dimethoxy silyl groups, diethoxy silyl groups, trimethoxy silyl groups, and triethoxy silyl groups.

Preferably, the one or more hydrolyzable silyl groups are covalently bonded to the polymeric backbone through spacers, wherein the spacers independently of one another are selected from —C₁₋₁₂-alkylene-, —C₃₋₈-cycloalkylene-, -phenyl-, —C₁₋₆-alkylene-phenyl-, —C₁₋₆-alkylene-phenyl-C₁₋₆-alkylene-, —C(═O)C₁₋₆-alkylene-, —S(═O)₂C₁₋₆-alkylene-, —NH—C₁₋₆-alkylene-, —NHC(═O)—C₁._-alkylene-, —C(═O)NHC₁₋₆-alkylene-, —NHS(═O)₂—C₁₋₆-alkylene-, —S(═O)₂NHC₁₋₆-alkylene-, —O—C₁₋₆-alkylene-, —OC(═O)—C₁₋₆-alkylene-, —C(═O)OC₁₋₆-alkylene-, —OS(═O)₂—C₁₋₆-alkylene-, —S(═O)₂OC₁₋₆-alkylene-, —OC(═O)NH—C₁₋₆-alkylene-, —NHC(═O)O—C₁₋₆-alkylene-, —OC(═O)O—C₁₋₆-alkylene-, —NHC(═O)NH—C₁₋₆-alkylene-, —O—[Si(CH₃)₂—O]₁₋₁₂—, azasilanes, and combinations thereof.

In preferred embodiments, the silyl-modified prepolymer is
an alpha silyl prepolymer; preferably wherein one or more hydrolyzable silyl groups are covalently bonded to the polymeric backbone through spacers, independently of one another selected from —CH₂—, —NH—CH₂—, —NHC(═O)—CH₂—, —C(═O)NH—CH₂—, —O—CH₂—, —OC(═O)—CH₂—, —C(═O)O—CH₂—, —OC(═O)NH—CH₂—, —NHC(═O)O—CH₂—, —OC(═O)O—CH₂—, and —NHC(═O)NH—CH₂—;
a beta silyl prepolymer; preferably wherein one or more hydrolyzable silyl groups are covalently bonded to the polymeric backbone through spacers, independently of one another selected from —CH₂CH₂—, —NH—CH₂CH₂—, —NHC(═O)—CH₂CH₂—, —C(═O)NH—CH₂CH₂—, —O—CH₂CH₂—, —OC(═O)CH₂CH₂—, —C(═O)O—CH₂CH₂—, —OC(═O)NH—CH₂CH₂—, —NHC(═O)O—CH₂CH₂—, —OC(═O)OCH₂CH₂—, and —NHC(═O)NH—CH₂CH₂—;
a gamma silyl prepolymer; preferably wherein one or more hydrolyzable silyl groups are covalently bonded to the polymeric backbone through spacers, independently of one another selected from —CH₂CH₂CH₂—, —NH—CH₂CH₂CH₂—, —NHC(═O)—CH₂CH₂CH₂—, —C(═O)NH—CH₂CH₂CH₂—, —O—CH₂CH₂CH₂—, —OC(═O)—CH₂CH₂CH₂—, —C(═O)O—CH₂CH₂CH₂—, —OC(═O)NH—CH₂CH₂CH₂—, —NHC(═O)O—CH₂CH₂CH₂—, —OC(═O)O—CH₂CH₂CH₂—, and —NHC(═O)NH—CH₂CH₂CH₂—; or
a delta silyl prepolymer; preferably wherein one or more hydrolyzable silyl groups are covalently bonded to the polymeric backbone through spacers, independently of one another selected from —CH₂CH₂CH₂CH₂—, —NH—CH₂CH₂CH₂CH₂—, —NHC(═O) —CH₂CH₂CH₂CH₂—, —C(═O)NH—CH₂CH₂CH₂CH₂—, —O—CH₂CH₂CH₂CH₂—, —OC(═O)—CH₂CH₂CH₂CH₂—, —C(═O)O—CH₂CH₂CH₂CH₂—, —OC(═O)NH—CH₂CH₂CH₂CH₂—, —NHC(═O)O—CH₂CH₂CH₂CH₂—, —OC(═O)O—CH₂CH₂CH₂CH₂—, and —NHC(═O)NH—CH₂CH₂CH₂CH₂—.

Preferably, the humidity-curable prepolymer comprises a polymeric backbone selected from the group consisting of polyethers, copolyethers, polyurethanes, copolyurethanes, polyesters, copolyesters, polyamides, copolyamids, polyolefins, copolyolefins, polystyrenes, copolystyrenes, polyacrylates, copolyacrylates, and mixtures thereof; preferably polyethers or copolyethers.

In preferred embodiments, the polymeric backbone is
a linear or branched, aliphatic and/or aromatic polyether comprising ether repetition units; or
a linear or branched, aliphatic and/or aromatic copolyether comprising ether repetition units and comonomer repetition units; preferably wherein the comonomer repetition units are selected from urethane repetition units, ester repetition units, amide repetition units, carbonate repetition units, urea repetition units, alkyl repetition units, and mixtures thereof.

Preferably, the humidity-curable prepolymer is selected from the group consisting of dimethoxy-silyl-terminated polyether or copolyether, trimethoxy-silyl-terminated polyether or copolyether, dimethoxy-silyl-terminated polyether or copolyether in each case reinforced with silicone moieties, trimethoxy-silyl-terminated polyether or copolyether in each case reinforced with silicone moieties, hydrophobically modified dimethoxy-silyl-terminated polyether or copolyether, monofunctional dimethoxy-silyl-terminated polyether or copolyether, and monofunctional trimethoxy-silyl-terminated polyether or copolyether.

Preferably, the humidity-curable prepolymer has a weight average molecular weight (ASTM D5296-19) within the range of from about 500 to 50,000 g/mol, preferably about 1000 to 25,000 g/mol.

Preferably, the humidity-curable prepolymer has a viscosity at 23 °C (ASTM D789, D4878), preferably determined with a Brookfield viscometer at 20 rpm using a #6 spindle, within the range of from about 100 to 35,000 mPa·s, preferably about 500 to 35,000 mPa·s.

Preferably, the weight content of the humidity-curable prepolymer in the first component is at least about 2.0 wt.-%, preferably at least about 3.0 wt.-%, more preferably at least about 4.0 wt.-%, still more preferably at least about 5.0 wt.-%, yet more preferably at least about 6.0 wt.-%, even more preferably at least about 7.0 wt.-%, most preferably at least about 8.0 wt.-%, and in particular at least about 9.0 wt.-%; in each case relative to the total weight of the first component.

Preferably, the weight content of the humidity-curable prepolymer in the first component is at least about 10 wt.-%, preferably at least about 15 wt.-%, more preferably at least about 20 wt.-%, still more preferably at least about 25 wt.-%, yet more preferably at least about 30 wt.-%, even more preferably at least about 35 wt.-%, most preferably at least about 40 wt.-%, and in particular at least about 45 wt.-%; in each case relative to the total weight of the first component.

Preferably, the weight content of the humidity-curable prepolymer in the first component is at most about 90 wt.-%, preferably at most about 85 wt.-%, more preferably at most about 80 wt.-%, still more preferably at most about 75 wt.-%, yet more preferably at most about 70 wt.-%, even more preferably at most about 65 wt.-%, most preferably at most about 60 wt.-%, and in particular at most about 55 wt.-%; more preferably less than 50 wt.-%; still more preferably at most about 45 wt.-%; in each case relative to the total weight of the first component.

Preferably, the weight content of the humidity-curable prepolymer in the first component is within the range of from about 10 to 90 wt.-%, preferably from about 20 to 80 wt.-%, more preferably from about 30 to 70 wt.-%, still more preferably from about 35 to 55 wt.-%; in each case relative to the total weight of the first component.

Preferably, the weight content of the humidity-curable prepolymer in the first component is within the range of from about 5.0 to 90 wt.-%, preferably from about 10 to 80 wt.-%, more preferably from about 15 to 75 wt.-%, still more preferably from about 25 to 60 wt.-%, yet more preferably from about 30 to 50 wt.-%; in each case relative to the total weight of the first component.

In preferred embodiments of the curable two-component system according to the invention,
the first component comprises a first portion of one or more humidity-curable prepolymers; preferably comprising or essentially consisting of one or more silyl-modified prepolymers; and
the second component comprises a second portion of one or more humidity-curable prepolymers; preferably comprising or essentially consisting of one or more silyl-modified prepolymers.

Preferably, at least one humidity-curable prepolymer that is contained in the first component is not contained in the second component; or vice versa.

Preferably, at least one humidity-curable prepolymer that is contained in the first component is also contained in the second component.

Preferably, the weight content of the humidity-curable prepolymer in the second component is at least about 5.0 wt.-%, preferably at least about 10 wt.-%, more preferably at least about 15 wt.-%, still more preferably at least about 20 wt.-%, yet more preferably at least about 25 wt.-%, even more preferably at least about 30 wt.-%, most preferably at least about 35 wt.-%, and in particular at least about 40 wt.-%; in each case relative to the total weight of the second component.

Preferably, the weight content of the humidity-curable prepolymer in the second component is at most about 90 wt.-%, preferably at most about 85 wt.-%, more preferably at most about 80 wt.-%, still more preferably at most about 75 wt.-%, yet more preferably at most about 70 wt.-%, even more preferably at most about 65 wt.-%, most preferably at most about 60 wt.-%, and in particular at most about 55 wt.-%; more preferably less than 50 wt.-%; still more preferably at most about 45 wt.-%; in each case relative to the total weight of the second component.

Preferably, the weight content of the humidity-curable prepolymer in the second component is within the range of from about 5.0 to 90 wt.-%, preferably from about 10 to 80 wt.-%, more preferably from about 15 to 70 wt.-%, still more preferably from about 25 to 55 wt.-%; in each case relative to the total weight of the second component.

Preferably, the weight content of the humidity-curable prepolymer in the second component is within the range of from about 10 to 90 wt.-%, preferably from about 20 to 80 wt.-%, more preferably from about 25 to 75 wt.-%, still more preferably from about 30 to 60 wt.-%, yet more preferably from about 30 to 50 wt.-%; in each case relative to the total weight of the second component.

In preferred embodiments of the curable two-component system according to the invention, the one or more basic inorganic fillers or anhydrides thereof comprise or essentially consist of one or more fillers having a pK_{A} value of at least about 7.5; preferably at least about 8.0, more preferably at least about 8.5, still more preferably at least about 9.0, yet more preferably at least about 9.5, even more preferably at least about 10.0, most preferably at least about 10.5, and in particular at least about 11.0.

In preferred embodiments, the pK_{A} value is within the range of from about 7.5 to 9.5.

Preferably, the pK_{A} value is at most about 14.0; preferably at most about 13.5, more preferably at most about 13.0, still more preferably at most about 12.5, yet more preferably at most about 12.0, even more preferably at most about 11.5, most preferably at most about 11.0, and in particular at most about 10.5.

In preferred embodiments, the one or more basic inorganic fillers or anhydrides thereof comprise or essentially consist of
one or more metal hydroxides; preferably selected from NaOH, KOH, Ca(OH)₂, Mg(OH)₂, Zn(OH)₂, Cu(OH)₂, Al(OH)₃, and any mixture thereof; more preferably selected from Ca(OH)₂, Mg(OH)₂, Zn(OH)₂, Cu(OH)₂, Al(OH)₃, and any mixture thereof; still more preferably Al(OH)₃;
one or more metal oxides and/or anhydrides of metal hydroxides; preferably selected from Na₂O, K₂O, CaO, MgO, ZnO, CuO, Al₂O₃, and any mixture thereof; more preferably selected from CaO, MgO, ZnO, CuO, Al₂O₃, and any mixture thereof; still more preferably MgO, ZnO, Al₂O₃, and any mixture thereof;
one or more nitrides, preferably covalent nitrides; more preferably selected from BN, AlN, GaN, InN, Cu₃N, and any mixture thereof; still more preferably BN, AlN, and any mixture thereof; or
any mixture thereof.

In other preferred embodiments, the one or more basic inorganic fillers or anhydrides thereof do not comprise NaOH and/or Na₂O.

Preferably, the one or more basic inorganic fillers or anhydrides thereof comprise or essentially consist of
one or more metal hydroxides; preferably selected from Ca(OH)₂, Mg(OH)₂, Zn(OH)₂, Cu(OH)₂, Al(OH)₃, and any mixture thereof; more preferably Al(OH)₃;
one or more metal oxides and/or anhydrides of metal hydroxides; preferably selected from CaO, MgO, ZnO, CuO, Al₂O₃, and any mixture thereof; more preferably MgO, ZnO, Al₂O₃, and any mixture thereof;
one or more nitrides, preferably covalent nitrides; more preferably selected from BN, AlN, GaN, InN, Cu₃N, and any mixture thereof; still more preferably BN, AlN, and any mixture thereof; or
any mixture thereof.

Preferably, the one or more basic inorganic fillers or anhydrides thereof comprise or essentially consist of Al(OH)₃, MgO, ZnO, Al₂O₃, BN, AlN, and any mixture thereof.

In preferred embodiments, the one or more basic inorganic fillers or anhydrides thereof do not comprise TiO₂, carbonates, in particular CaCO₃, silica, in particular fumed silica, and/or kaolinite.

Suitable basic inorganic fillers are commercially available (e.g. AlOx Sigma Aldrich, Alteo TIM-al 17, Alteo TimAl-G4, Alteo TimAl-H2, Alteo TimAl-H3).

Preferably, the total weight content of all the one or more basic inorganic fillers or anhydrides thereof (e.g. Na-donors, K-donors, Al(OH)₃, MgO, ZnO, and Al₂O₃) in the first component and/or in the second component independently from one another is at least about 0.5 wt.-%, preferably at least about 1.0 wt.-%, more preferably at least about 2.0 wt.-%, still more preferably at least about 4.0 wt.-%, yet more preferably at least about 6.0 wt.-%, even more preferably at least about 8.0 wt.-%, most preferably at least about 10 wt.-%, and in particular at least about 12 wt.-%; in each case relative to the total weight of the first component and of the second component, respectively.

Preferably, the total weight content of all the one or more basic inorganic fillers or anhydrides thereof (e.g. Na-donors, K-donors, Al(OH)₃, MgO, ZnO, and Al₂O₃) in the first component and/or in the second component independently from one another is at least about 15 wt.-%, preferably at least about 20 wt.-%, more preferably at least about 25 wt.-%, still more preferably at least about 30 wt.-%, yet more preferably at least about 35 wt.-%, even more preferably at least about 40 wt.-%, most preferably at least about 45 wt.-%, and in particular at least about 50 wt.-%; in each case relative to the total weight of the first component and of the second component, respectively.

Preferably, the total weight content of all the one or more basic inorganic fillers or anhydrides thereof (e.g. Na-donors, K-donors, Al(OH)₃, MgO, ZnO, and Al₂O₃) in the first component and/or in the second component independently from one another is at most about 80 wt.-%, preferably at most about 78 wt.-%, more preferably at most about 76 wt.-%, still more preferably at most about 74 wt.-%, yet more preferably at most about 72 wt.-%, even more preferably at most about 70 wt.-%, most preferably at most about 68 wt.-%, and in particular at most about 66 wt.-%; in each case relative to the total weight of the first component and of the second component, respectively.

Preferably, the total weight content of all the one or more basic inorganic fillers or anhydrides thereof (e.g. Na-donors, K-donors, Al(OH)₃, MgO, ZnO, and Al₂O₃) in the first component and/or in the second component independently from one another is at most about 65 wt.-%, preferably at most about 60 wt.-%, more preferably at most about 55 wt.-%, still more preferably at most about 50 wt.-%, yet more preferably at most about 45 wt.-%, even more preferably at most about 40 wt.-%, most preferably at most about 35 wt.-%, and in particular at most about 30 wt.-%; more preferably less than 25 wt.-%; still more preferably at most about 20 wt.-%; in each case relative to the total weight of the first component and of the second component, respectively.

Preferably, the total weight content of all the one or more basic inorganic fillers or anhydrides thereof (e.g. Na-donors, K-donors, Al(OH)₃, MgO, ZnO, and Al₂O₃) in the first component and/or in the second component independently from one another is within the range of from about 5.0 to 75 wt.-%, preferably from about 10 to 70 wt.-%, more preferably from about 20 to 65 wt.-%, still more preferably from about 45 to 60 wt.-%; in each case relative to the total weight of the first component and of the second component, respectively.

Preferably, the total weight content of all the one or more basic inorganic fillers or anhydrides thereof (e.g. Na-donors, K-donors, Al(OH)₃, MgO, ZnO, and Al₂O₃) in the first component and/or in the second component independently from one another is within the range of from about 0.5 to 65 wt.-%, preferably from about 5.0 to 50 wt.-%, more preferably from about 10 to 45 wt.-%, still more preferably from about 12 to 30 wt.-%; in each case relative to the total weight of the first component and of the second component, respectively.

Preferably, the total weight content of all the one or more basic inorganic fillers or anhydrides thereof (e.g. Al(OH)₃, MgO, ZnO, and Al₂O₃) without the weight content of NaOH and/or Na₂O in the first component and/or in the second component independently from one another is at least about 0.5 wt.-%, preferably at least about 1.0 wt.-%, more preferably at least about 2.0 wt.-%, still more preferably at least about 4.0 wt.-%, yet more preferably at least about 6.0 wt.-%, even more preferably at least about 8.0 wt.-%, most preferably at least about 10 wt.-%, and in particular at least about 12 wt.-%; in each case relative to the total weight of the first component and of the second component, respectively.

Preferably, the total weight content of all the one or more basic inorganic fillers or anhydrides thereof (e.g. Al(OH)₃, MgO, ZnO, and Al₂O₃) without the weight content of NaOH and/or Na₂O in the first component and/or in the second component independently from one another is at least about 15 wt.-%, preferably at least about 20 wt.-%, more preferably at least about 25 wt.-%, still more preferably at least about 30 wt.-%, yet more preferably at least about 35 wt.-%, even more preferably at least about 40 wt.-%, most preferably at least about 45 wt.-%, and in particular at least about 50 wt.-%; in each case relative to the total weight of the first component and of the second component, respectively.

Preferably, the total weight content of all the one or more basic inorganic fillers or anhydrides thereof (e.g. Al(OH)₃, MgO, ZnO, and Al₂O₃) without the weight content of NaOH and/or Na₂O in the first component and/or in the second component independently from one another is at most about 80 wt.-%, preferably at most about 78 wt.-%, more preferably at most about 76 wt.-%, still more preferably at most about 74 wt.-%, yet more preferably at most about 72 wt.-%, even more preferably at most about 70 wt.-%, most preferably at most about 68 wt.-%, and in particular at most about 66 wt.-%; in each case relative to the total weight of the first component and of the second component, respectively.

Preferably, the total weight content of all the one or more basic inorganic fillers or anhydrides thereof (e.g. Al(OH)₃, MgO, ZnO, and Al₂O₃) without the weight content of NaOH and/or Na₂O in the first component and/or in the second component independently from one another is at most about 65 wt.-%, preferably at most about 60 wt.-%, more preferably at most about 55 wt.-%, still more preferably at most about 50 wt.-%, yet more preferably at most about 45 wt.-%, even more preferably at most about 40 wt.-%, most preferably at most about 35 wt.-%, and in particular at most about 30 wt.-%; more preferably less than 25 wt.-%; still more preferably at most about 20 wt.-%; in each case relative to the total weight of the first component and of the second component, respectively.

Preferably, the total weight content of all the one or more basic inorganic fillers or anhydrides thereof (e.g. Al(OH)₃, MgO, ZnO, and Al₂O₃) without the weight content of NaOH and/or Na₂O in the first component and/or in the second component independently from one another is within the range of from about 5.0 to 75 wt.-%, preferably from about 10 to 70 wt.-%, more preferably from about 20 to 65 wt.-%, still more preferably from about 45 to 60 wt.-%; in each case relative to the total weight of the first component and of the second component, respectively.

Preferably, the total weight content of all the one or more basic inorganic fillers or anhydrides thereof (e.g. Al(OH)₃, MgO, ZnO, and Al₂O₃) without the weight content of NaOH and/or Na₂O in the first component and/or in the second component independently from one another is within the range of from about 0.5 to 65 wt.-%, preferably from about 5.0 to 50 wt.-%, more preferably from about 10 to 45 wt.-%, still more preferably from about 12 to 30 wt.-%; in each case relative to the total weight of the first component and of the second component, respectively.

In preferred embodiments of the curable two-component system according to the invention, the first component and/or the second component, preferably the first component, comprises one or more donors for Na⁺ ions (Na-donors); preferably independently from one another selected from Na₂O, NaOH, and a mixture thereof; more preferably Na₂O.

In preferred embodiments, the curable two-component system according to the invention comprises
one or more donors for Na⁺ ions (Na-donors); preferably independently from one another selected from Na₂O, NaOH, and a mixture thereof; and
the one or more basic inorganic fillers or anhydrides thereof; preferably wherein the one or more basic inorganic fillers or anhydrides thereof comprise or essentially consist of Al(OH)₃, MgO, ZnO, Al₂O₃, BN, AlN, and any mixture thereof.

For the purpose of the specification, donors for Na⁺ ions (Na-donors) are capable of dissociating into Na⁺ ions and corresponding anions when they come into contact with water. While donors for Na⁺ ions may be the sodium salts of acids such as mineral acids (e.g. NaCl, NaBr, Na₂SO₄, Na₃PO₄, and the like), basic sodium salts are preferred (e.g. Na₂O, NaOH, NaHCO₃, Na₂CO₃, and the like).

It is contemplated that the basic inorganic fillers or anhydrides thereof (e.g. Al(OH)₃, MgO, ZnO, and Al₂O₃) may hydrolyze and/or react when mixed with water and that the reaction products are also encompassed. Thus, for example, when the basic inorganic filler is Al(OH)₃, it may at least partially react to [Al(OH)₄]⁻. Likewise, Na₂O may hydrolyze and/or react to NaOH when contacted with water.

Preferably, the weight content of the one or more donors for Na⁺ ions (Na-donors) in the first component and/or in the second component, preferably the first component, independently from one another is at least about 0.010 wt.-%, preferably at least about 0.015 wt.-%, more preferably at least about 0.020 wt.-%, still more preferably at least about 0.025 wt.-%, yet more preferably at least about 0.030 wt.-%, even more preferably at least about 0.035 wt.-%, most preferably at least about 0.040 wt. %, and in particular at least about 0.045 wt.-%; in each case relative to the total weight of the first component and of the second component, respectively.

Preferably, the weight content of the one or more donors for Na⁺ ions (Na-donors) in the first component and/or in the second component independently from one another is at least about 0.05 wt. %, preferably at least about 0.1 wt.-%, more preferably at least about 0.2 wt.-%, still more preferably at least about 0.4 wt.-%, yet more preferably at least about 0.6 wt.-%, even more preferably at least about 0.8 wt.-%, most preferably at least about 1.0 wt.-%, and in particular at least about 1.2 wt.-%; in each case relative to the total weight of the first component and of the second component, respectively.

Preferably, the weight content of the one or more donors for Na⁺ ions (Na-donors) in the first component and/or in the second component independently from one another is at most about 15 wt.-%, preferably at most about 10 wt.-%, more preferably at most about 8.0 wt.-%; in each case relative to the total weight of the first component and of the second component, respectively.

Preferably, the weight content of the one or more donors for Na⁺ ions (Na-donors) in the first component and/or in the second component independently from one another is at most about 6.5 wt.-%, preferably at most about 6.0 wt.-%, more preferably at most about 5.5 wt.-%, still more preferably at most about 5.0 wt.-%, yet more preferably at most about 4.5 wt.-%, even more preferably at most about 4.0 wt.-%, most preferably at most about 3.5 wt.-%, and in particular at most about 3.0 wt.-%; more preferably less than 2.5 wt.-%; still more preferably at most about 2.0 wt.-%; in each case relative to the total weight of the first component and of the second component, respectively.

Preferably, the weight content of the one or more donors for Na⁺ ions (Na-donors) in the first component and/or in the second component, preferably the first component, independently from one another is at most about 1.50 wt.-%, preferably at most about 1.00 wt.-%, more preferably at most about 0.50 wt.-%, still more preferably at most about 0.25 wt.-%, yet more preferably at most about 0.10 wt.-% even more preferably at most about 0.09 wt.-%, most preferably at most about 0.08 wt.-%, and in particular at most about 0.07 wt.-%; in each case relative to the total weight of the first component and of the second component, respectively.

Preferably, the weight content of the one or more donors for Na⁺ ions (Na-donors) in the first component and/or in the second component independently from one another is within the range of from about 0.05 to 3.0 wt.-%, preferably from about 0.5 to 2.4 wt.-%, more preferably from about 0.8 to 2.1 wt.-%, still more preferably from about 1.1 to 1.9 wt.-%; in each case relative to the total weight of the first component and of the second component, respectively.

Preferably, the weight content of the one or more donors for Na⁺ ions (Na-donors) in the first component and/or in the second component, preferably the first component, independently from one another is within the range of from about 0.02 to 1.0 wt.-%, preferably from about 0.03 to 0.5 wt.-%, more preferably from about 0.04 to 0.10 wt.-%, still more preferably from about 0.04 to 0.07 wt.-%; in each case relative to the total weight of the first component and of the second component, respectively.

Preferably, the content of the one or more donors for Na⁺ ions (Na-donors) in the first component and/or in the second component, preferably the first component, independently from one another is at least about 100 ppm, preferably at least about 150 ppm, more preferably at least about 200 ppm, still more preferably at least about 250 ppm, yet more preferably at least about 300 ppm, even more preferably at least about 350 ppm, most preferably at least about 400 ppm, and in particular at least about 450 ppm; in each case relative to the first component and the second component, respectively.

Preferably, the content of the one or more donors for Na⁺ ions (Na-donors) in the first component and/or in the second component, preferably the first component, independently from one another is at most about 1200 ppm, preferably at most about 1100 ppm, more preferably at most about 1000 ppm, still more preferably at most about 950 ppm, yet more preferably at most about 900 ppm, even more preferably at most about 850 ppm, most preferably at most about 800 ppm, and in particular at most about 750 ppm; in each case relative to the first component and the second component, respectively.

Preferably, the content of the one or more donors for Na⁺ ions (Na-donors) in the first component and/or in the second component, preferably the first component, independently from one another is within the range of from about 300 to 1000 ppm, preferably from about 350 to 900 ppm, more preferably from about 400 to 800 ppm, still more preferably from about 400 to 700 ppm; in each case relative to the first component and the second component, respectively.

In preferred embodiments of the curable two-component system according to the invention, the first component and/or the second component, preferably the first component, comprises one or more donors for K⁺ ions (K-donors); preferably independently from one another selected from K₂O, KOH, and a mixture thereof.

For the purpose of the specification, donors for K⁺ ions (K-donors) are capable of dissociating into K⁺ ions and corresponding anions when they come into contact with water. While donors for K⁺ ions may be the potassium salts of acids such as mineral acids (e.g. KCl, KBr, K₂SO₄, K₃PO₄, and the like), basic potassium salts are preferred (e.g. K₂O, KOH, KHCO₃, K₂CO₃, and the like).

Preferably, the weight content of the one or more donors for K⁺ ions (K-donors) in the first component and/or in the second component independently from one another is at least about 0.05 wt. %, preferably at least about 0.010 wt.-%, preferably at least about 0.015 wt.-%, more preferably at least about 0.020 wt.-%, still more preferably at least about 0.025 wt.-%, yet more preferably at least about 0.030 wt.-%, even more preferably at least about 0.035 wt.-%, most preferably at least about 0.040 wt. %, and in particular at least about 0.045 wt.-%; in each case relative to the total weight of the first component and of the second component, respectively.

Preferably, the weight content of the one or more donors for K⁺ ions (K-donors) in the first component and/or in the second component independently from one another is at least about 0.05 wt. %, preferably at least about 0.1 wt.-%, more preferably at least about 0.2 wt.-%, still more preferably at least about 0.4 wt.-%, yet more preferably at least about 0.6 wt.-%, even more preferably at least about 0.8 wt.-%, most preferably at least about 1.0 wt.-%, and in particular at least about 1.2 wt.-%; in each case relative to the total weight of the first component and of the second component, respectively.

Preferably, the weight content of the one or more donors for K⁺ ions (K-donors) in the first component and/or in the second component independently from one another is at most about 15 wt.-%, preferably at most about 10 wt.-%, more preferably at most about 8.0 wt.-%; in each case relative to the total weight of the first component and of the second component, respectively.

Preferably, the weight content of the one or more donors for K⁺ ions (K-donors) in the first component and/or in the second component independently from one another is at most about 6.5 wt.-%, preferably at most about 6.0 wt.-%, more preferably at most about 5.5 wt.-%, still more preferably at most about 5.0 wt.-%, yet more preferably at most about 4.5 wt.-%, even more preferably at most about 4.0 wt.-%, most preferably at most about 3.5 wt.-%, and in particular at most about 3.0 wt.-%; more preferably less than 2.5 wt.-%; still more preferably at most about 2.0 wt.-%; in each case relative to the total weight of the first component and of the second component, respectively.

Preferably, the weight content of the one or more donors for K⁺ ions (K-donors) in the first component and/or in the second component, preferably the first component, independently from one another is at most about 1.50 wt.-%, preferably at most about 1.00 wt.-%, more preferably at most about 0.50 wt.-%, still more preferably at most about 0.25 wt.-%, yet more preferably at most about 0.10 wt.-%, even more preferably at most about 0.09 wt.-%, most preferably at most about 0.08 wt.-%, and in particular at most about 0.07 wt.-%; in each case relative to the total weight of the first component and of the second component, respectively.

Preferably, the weight content of the one or more donors for K⁺ ions (K-donors) in the first component and/or in the second component independently from one another is within the range of from about 0.05 to 3.0 wt.-%, preferably from about 0.5 to 2.4 wt.-%, more preferably from about 0.8 to 2.1 wt.-%, still more preferably from about 1.1 to 1.9 wt.-%; in each case relative to the total weight of the first component and of the second component, respectively.

Preferably, the weight content of the one or more donors for K⁺ ions (K-donors) in the first component and/or in the second component, preferably the first component, independently from one another is within the range of from about 0.02 to 1.0 wt.-%, preferably from about 0.03 to 0.5 wt.-%, more preferably from about 0.04 to 0.10 wt.-%, still more preferably from about 0.04 to 0.07 wt.-%; in each case relative to the total weight of the first component and of the second component, respectively.

Preferably, the content of the one or more donors for K⁺ ions (K-donors) in the first component and/or in the second component, preferably the first component, independently from one another is at least about 100 ppm, preferably at least about 150 ppm, more preferably at least about 200 ppm, still more preferably at least about 250 ppm, yet more preferably at least about 300 ppm, even more preferably at least about 350 ppm, most preferably at least about 400 ppm, and in particular at least about 450 ppm; in each case relative to the first component and the second component, respectively.

Preferably, the content of the one or more donors for K⁺ ions (K-donors) in the first component and/or in the second component, preferably the first component, independently from one another is at most about 1200 ppm, preferably at most about 1100 ppm, more preferably at most about 1000 ppm, still more preferably at most about 950 ppm, yet more preferably at most about 900 ppm, even more preferably at most about 850 ppm, most preferably at most about 800 ppm, and in particular at most about 750 ppm; in each case relative to the first component and the second component, respectively.

Preferably, the content of the one or more donors for K⁺ ions (K-donors) in the first component and/or in the second component, preferably the first component, independently from one another is within the range of from about 300 to 1000 ppm, preferably from about 350 to 900 ppm, more preferably from about 400 to 800 ppm, still more preferably from about 400 to 700 ppm; in each case relative to the first component and the second component, respectively.

In preferred embodiments of the curable two-component system according to the invention, the first component and/or the second component, preferably the first component, comprises Al(OH)₃.

Preferably, the weight content of the Al(OH)₃ in the first component and/or in the second component independently from one another is at least about 0.04 wt.-%, preferably at least about 0.1 wt.-%; preferably at least about 0.3 wt.-%, preferably at least about 0.6 wt.-%, more preferably at least about 0.9 wt.-%, still more preferably at least about 1.2 wt.-%, yet more preferably at least about 1.5 wt.-%, even more preferably at least about 1.8 wt.-%, most preferably at least about 2.1 wt.-%, and in particular at least about 2.4 wt.-%; in each case relative to the total weight of the first component and of the second component, respectively.

Preferably, the weight content of the Al(OH)₃ in the first component and/or in the second component independently from one another is at least about 10 wt.-%, preferably at least about 15 wt.-%, more preferably at least about 20 wt.-%, still more preferably at least about 25 wt.-%, yet more preferably at least about 30 wt.-%, even more preferably at least about 35 wt.-%, most preferably at least about 40 wt.-%, and in particular at least about 45 wt.-%; in each case relative to the total weight of the first component and of the second component, respectively.

Preferably, the weight content of the Al(OH)₃ in the first component and/or in the second component independently from one another is at most about 82 wt.-%, preferably at most about 79 wt.-%, more preferably at most about 76 wt.-%, still more preferably at most about 73 wt.-%, yet more preferably at most about 70 wt.-%, even more preferably at most about 67 wt.-%, most preferably at most about 64 wt.-%, and in particular at most about 61 wt.-%; more preferably less than 58 wt.-%; still more preferably at most about 55 wt.-%; in each case relative to the total weight of the first component and of the second component, respectively.

Preferably, the weight content of the Al(OH)₃ in the first component and/or in the second component independently from one another is at most about 15 wt.-%, preferably at most about 14 wt.-%, more preferably at most about 13 wt.-%, still more preferably at most about 12 wt.-%, yet more preferably at most about 11 wt.-%, even more preferably at most about 10 wt.-%, most preferably at most about 9.0 wt.-%, and in particular at most about 8.0 wt.-%; more preferably less than 7.0 wt.-%; still more preferably at most about 6.0 wt.-%; in each case relative to the total weight of the first component and of the second component, respectively.

Preferably, the weight content of the Al(OH)₃ in the first component and/or in the second component independently from one another is within the range of from about 30 to 75 wt.-%, preferably from about 35 to 70 wt.-%, more preferably from about 40 to 65 wt.-%, still more preferably from about 45 to 60 wt.-%; in each case relative to the total weight of the first component and of the second component, respectively.

Preferably, the weight content of the Al(OH)₃ in the first component and/or in the second component independently from one another is within the range of from about 0.1 to 15 wt.-%, preferably from about 1.0 to 12 wt.-%, more preferably from about 2.0 to 10 wt.-%, still more preferably from about 2.5 to 6.0 wt.-%; in each case relative to the total weight of the first component and of the second component, respectively.

In preferred embodiments of the curable two-component system according to the invention, the first component and/or the second component, preferably the first component, comprises MgO.

Preferably, the weight content of the MgO in the first component and/or in the second component independently from one another is at least about 10 wt.-%, preferably at least about 15 wt.-%, more preferably at least about 20 wt.-%, still more preferably at least about 25 wt.-%, yet more preferably at least about 30 wt.-%, even more preferably at least about 35 wt.-%, most preferably at least about 40 wt.-%, and in particular at least about 45 wt.-%; in each case relative to the total weight of the first component and of the second component, respectively.

Preferably, the weight content of the MgO in the first component and/or in the second component independently from one another is at most about 82 wt.-%, preferably at most about 79 wt.-%, more preferably at most about 76 wt.-%, still more preferably at most about 73 wt.-%, yet more preferably at most about 70 wt.-%, even more preferably at most about 67 wt.-%, most preferably at most about 64 wt.-%, and in particular at most about 61 wt.-%; more preferably less than 58 wt.-%; still more preferably at most about 55 wt.-%; in each case relative to the total weight of the first component and of the second component, respectively.

Preferably, the weight content of the MgO in the first component and/or in the second component independently from one another is at least about 0.04 wt.-%, preferably at least about 0.1 wt.-%; preferably at least about 0.3 wt.-%, preferably at least about 0.6 wt.-%, more preferably at least about 0.9 wt.-%, still more preferably at least about 1.2 wt.-%, yet more preferably at least about 1.5 wt.-%, even more preferably at least about 1.8 wt.-%, most preferably at least about 2.1 wt.-%, and in particular at least about 2.4 wt.-%; in each case relative to the total weight of the first component and of the second component, respectively.

Preferably, the weight content of the MgO in the first component and/or in the second component independently from one another is at most about 15 wt.-%, preferably at most about 14 wt.-%, more preferably at most about 13 wt.-%, still more preferably at most about 12 wt.-%, yet more preferably at most about 11 wt.-%, even more preferably at most about 10 wt.-%, most preferably at most about 9.0 wt.-%, and in particular at most about 8.0 wt.-%; more preferably less than 7.0 wt.-%; still more preferably at most about 6.0 wt.-%; in each case relative to the total weight of the first component and of the second component, respectively.

Preferably, the weight content of the MgO in the first component and/or in the second component independently from one another is within the range of from about 30 to 75 wt.-%, preferably from about 35 to 70 wt.-%, more preferably from about 40 to 65 wt.-%, still more preferably from about 45 to 60 wt.-%; in each case relative to the total weight of the first component and of the second component, respectively.

Preferably, the weight content of the MgO in the first component and/or in the second component independently from one another is within the range of from about 0.1 to 15 wt.-%, preferably from about 1.0 to 12 wt.-%, more preferably from about 2.0 to 10 wt.-%, still more preferably from about 2.5 to 6.0 wt.-%; in each case relative to the total weight of the first component and of the second component, respectively.

In preferred embodiments of the curable two-component system according to the invention, the first component and/or the second component, preferably the first component, comprises ZnO.

Preferably, the weight content of the ZnO in the first component and/or in the second component independently from one another is at least about 10 wt.-%, preferably at least about 15 wt.-%, more preferably at least about 20 wt.-%, still more preferably at least about 25 wt.-%, yet more preferably at least about 30 wt.-%, even more preferably at least about 35 wt.-%, most preferably at least about 40 wt.-%, and in particular at least about 45 wt.-%; in each case relative to the total weight of the first component and of the second component, respectively.

Preferably, the weight content of the ZnO in the first component and/or in the second component independently from one another is at most about 82 wt.-%, preferably at most about 79 wt.-%, more preferably at most about 76 wt.-%, still more preferably at most about 73 wt.-%, yet more preferably at most about 70 wt.-%, even more preferably at most about 67 wt.-%, most preferably at most about 64 wt.-%, and in particular at most about 61 wt.-%; more preferably less than 58 wt.-%; still more preferably at most about 55 wt.-%; in each case relative to the total weight of the first component and of the second component, respectively.

Preferably, the weight content of the ZnO in the first component and/or in the second component independently from one another is at least about 0.04 wt.-%, preferably at least about 0.1 wt.-%; preferably at least about 0.3 wt.-%, preferably at least about 0.6 wt.-%, more preferably at least about 0.9 wt. %, still more preferably at least about 1.2 wt.-%, yet more preferably at least about 1.5 wt.-%, even more preferably at least about 1.8 wt.-%, most preferably at least about 2.1 wt.-%, and in particular at least about 2.4 wt.-%; in each case relative to the total weight of the first component and of the second component, respectively.

Preferably, the weight content of the ZnO in the first component and/or in the second component independently from one another is at most about 15 wt.-%, preferably at most about 14 wt.-%, more preferably at most about 13 wt.-%, still more preferably at most about 12 wt.-%, yet more preferably at most about 11 wt.-%, even more preferably at most about 10 wt.-%, most preferably at most about 9.0 wt.-%, and in particular at most about 8.0 wt.-%; more preferably less than 7.0 wt.-%; still more preferably at most about 6.0 wt.-%; in each case relative to the total weight of the first component and of the second component, respectively.

Preferably, the weight content of the ZnO in the first component and/or in the second component independently from one another is within the range of from about 30 to 75 wt.-%, preferably from about 35 to 70 wt.-%, more preferably from about 40 to 65 wt.-%, still more preferably from about 45 to 60 wt.-%; in each case relative to the total weight of the first component and of the second component, respectively.

Preferably, the weight content of the ZnO in the first component and/or in the second component independently from one another is within the range of from about 0.1 to 15 wt.-%, preferably from about 1.0 to 12 wt.-%, more preferably from about 2.0 to 10 wt.-%, still more preferably from about 2.5 to 6.0 wt.-%; in each case relative to the total weight of the first component and of the second component, respectively.

In preferred embodiments of the curable two-component system according to the invention, the first component and/or the second component, preferably the first component, comprises Al₂O₃.

Preferably, the weight content of the Al₂O₃ in the first component and/or in the second component independently from one another is at least about 10 wt.-%, preferably at least about 15 wt.-%, more preferably at least about 20 wt.-%, still more preferably at least about 25 wt.-%, yet more preferably at least about 30 wt.-%, even more preferably at least about 35 wt.-%, most preferably at least about 40 wt.-%, and in particular at least about 45 wt.-%; in each case relative to the total weight of the first component and of the second component, respectively.

Preferably, the weight content of the Al₂O₃ in the first component and/or in the second component independently from one another is at most about 82 wt.-%, preferably at most about 79 wt.-%, more preferably at most about 76 wt.-%, still more preferably at most about 73 wt.-%, yet more preferably at most about 70 wt.-%, even more preferably at most about 67 wt.-%, most preferably at most about 64 wt.-%, and in particular at most about 61 wt.-%; more preferably less than 58 wt.-%; still more preferably at most about 55 wt.-%; in each case relative to the total weight of the first component and of the second component, respectively.

Preferably, the weight content of the Al₂O₃ in the first component and/or in the second component independently from one another is at least about 0.04 wt.-%, preferably at least about 0.1 wt.-%; preferably at least about 0.3 wt.-%, preferably at least about 0.6 wt.-%, more preferably at least about 0.9 wt.-%, still more preferably at least about 1.2 wt.-%, yet more preferably at least about 1.5 wt.-%, even more preferably at least about 1.8 wt.-%, most preferably at least about 2.1 wt.-%, and in particular at least about 2.4 wt.-%; in each case relative to the total weight of the first component and of the second component, respectively.

Preferably, the weight content of the Al₂O₃ in the first component and/or in the second component independently from one another is at most about 15 wt.-%, preferably at most about 14 wt.-%, more preferably at most about 13 wt.-%, still more preferably at most about 12 wt.-%, yet more preferably at most about 11 wt.-%, even more preferably at most about 10 wt.-%, most preferably at most about 9.0 wt.-%, and in particular at most about 8.0 wt.-%; more preferably less than 7.0 wt.-%; still more preferably at most about 6.0 wt.-%; in each case relative to the total weight of the first component and of the second component, respectively.

Preferably, the weight content of the Al₂O₃ in the first component and/or in the second component independently from one another is within the range of from about 30 to 75 wt.-%, preferably from about 35 to 70 wt.-%, more preferably from about 40 to 65 wt.-%, still more preferably from about 45 to 60 wt.-%; in each case relative to the total weight of the first component and of the second component, respectively.

Preferably, the weight content of the Al₂O₃ in the first component and/or in the second component independently from one another is within the range of from about 0.1 to 15 wt.-%, preferably from about 1.0 to 12 wt.-%, more preferably from about 2.0 to 10 wt.-%, still more preferably from about 2.5 to 6.0 wt.-%; in each case relative to the total weight of the first component and of the second component, respectively.

In preferred embodiments of the curable two-component system according to the invention, the first component and/or the second component, preferably the first component, comprises SiO₂; preferably other than fumed silica (pyrogenic silica); more preferably the SiO₂ is selected from the group consisting of precipitated silica, fused silica, colloidal silica, silica gel, silica aerogel, and silica xerogel.

Preferably, the weight content of the SiO₂ in the first component and/or in the second component independently from one another is at least about 0.04 wt.-%, preferably at least about 0.1 wt.-%; preferably at least about 0.3 wt.-%, preferably at least about 0.6 wt.-%, more preferably at least about 0.9 wt. %, still more preferably at least about 1.2 wt.-%, yet more preferably at least about 1.5 wt.-%, even more preferably at least about 1.8 wt.-%, most preferably at least about 2.1 wt.-%, and in particular at least about 2.4 wt.-%; in each case relative to the total weight of the first component and of the second component, respectively.

Preferably, the weight content of the SiO₂ in the first component and/or in the second component independently from one another is at most about 15 wt.-%, preferably at most about 14 wt.-%, more preferably at most about 13 wt.-%, still more preferably at most about 12 wt.-%, yet more preferably at most about 11 wt.-%, even more preferably at most about 10 wt.-%, most preferably at most about 9.0 wt.-%, and in particular at most about 8.0 wt.-%; more preferably less than 7.0 wt.-%; still more preferably at most about 6.0 wt.-%; in each case relative to the total weight of the first component and of the second component, respectively.

Preferably, the weight content of the SiO₂ in the first component and/or in the second component independently from one another is within the range of from about 0.1 to 15 wt.-%, preferably from about 1.0 to 12 wt.-%, more preferably from about 2.0 to 10 wt.-%, still more preferably from about 2.5 to 6.0 wt.-%; in each case relative to the total weight of the first component and of the second component, respectively.

Preferably, the weight content of the SiO₂ in the first component and/or in the second component independently from one another is at most about 4.0 wt.-%, preferably at most about 3.5 wt.-%, more preferably at most about 3.0 wt.-%, still more preferably at most about 2.5 wt.-%, yet more preferably at most about 2.0 wt.-%, even more preferably at most about 1.5 wt.-%, most preferably at most about 1.0 wt.-%, and in particular at most about 0.5 wt.-%; in each case relative to the total weight of the first component and of the second component, respectively; preferably the curable two-component system does not comprise SiO₂.

In preferred embodiments of the curable two-component system according to the invention, the first component and/or the second component, preferably the first component, comprises fumed silica (pyrogenic silica), preferably hydrophobic fumed silica.

The curable two-component system according to the invention may comprise a single kind of fumed silica or a mixture of two or more kinds of fumed silica. In case of the presence of two or more kinds of fumed silica, all weights and percentages refer to the total weight of all kinds of fumed silica that are contained in the curable two-component system.

It has been surprisingly found that fumed silica, especially certain grades of fumed silica, have a positive effect on multi-substrate adhesion including glass, durability and high strength.

In preferred embodiments, the fumed silica is untreated.

In other preferred embodiments, the fumed silica is organically modified; preferably hydrophobic fumed silica; more preferably treated with optionally functionalized halotrialkylsilane or optionally functionalized dihalodialkylsilane; more preferably with trimethyl silyl groups; still more preferably with polydimethylsiloxane, hexamethyldisilazane or dimethyldichlorosilane; most preferably polydimethylsiloxane.

Preferably, the fumed silica has a Brunauer-Emmett-Teller (BET) surface area (ISO 9277) of at least about 50 m²/g, preferably at least about 60 m²/g, more preferably at least about 70 m²/g, still more preferably at least about 80 m²/g, yet more preferably at least about 90 m²/g, even more preferably at least about 100 m²/g, most preferably at least about 110 m²/g, and in particular at least about 120 m²/g.

Preferably, the fumed silica has a Brunauer-Emmett-Teller (BET) surface area (ISO 9277) of at most about 600 m²/g, preferably at most about 580 m²/g, more preferably at most about 560 m²/g, still more preferably at most about 540 m²/g, yet more preferably at most about 520 m²/g, even more preferably at most about 500 m²/g, most preferably at most about 480 m²/g, and in particular at most about 460 m²/g.

Preferably, the fumed silica has a Brunauer-Emmett-Teller (BET) surface area (ISO 9277) within the range of about 50±25 m²/g, or 75±25 m²/g, or 100±25 m²/g, or 125±25 m²/g, or 150±25 m²/g, or 175±25 m²/g, or 200±25 m²/g, or 225±25 m²/g, or 250±25 m²/g, or 275±25 m²/g, or 300±25 m²/g, or 325±25 m²/g, or 350±25 m²/g, or 375±25 m²/g, or 400±25 m²/g, or 425±25 m²/g, or 450±25 m²/g, or 475±25 m²/g, or 500±25 m²/g, or 525±25 m²/g, or 550±25 m²/g, or 575±25 m²/g, or 600±25 m²/g; preferably about 180 to 220 m²/g.

In particularly preferred embodiments, the fumed silica has a Brunauer-Emmett-Teller (BET) surface area (ISO 9277) within the range of from about 150 to 250 m²/g, preferably about 160 to 240 m²/g, more preferably about 170 to 230 m²/g.

Preferably, the fumed silica has a mean primary particle size determined by photon correlation spectroscopy (PCS) of at least about 1.0 nm, preferably at least about 2.0 nm, more preferably at least about 3.0 nm, still more preferably at least about 4.0 nm, yet more preferably at least about 5.0 nm, even more preferably at least about 6.0 nm, most preferably at least about 7.0 nm, and in particular at least about 8.0 nm.

Preferably, the fumed silica has a mean primary particle size determined by photon correlation spectroscopy (PCS) of at most about 100 nm, preferably at most about 90 nm, more preferably at most about 80 nm, still more preferably at most about 70 nm, yet more preferably at most about 60 nm, even more preferably at most about 50 nm, most preferably at most about 40 nm, and in particular at most about 30 nm.

Preferably, the fumed silica has a mean primary particle size determined by photon correlation spectroscopy (PCS) within the range of about 10±5 nm, or 15±5 nm, or 20±5 nm, or 25±5 nm, or 30±5 nm, or 35±5 nm, or 40±5 nm, or 45±5 nm, or 50±5 nm.

Preferably, the fumed silica has a tamped density (ISO 787/11) of at least about 40 g/l, preferably at least about 50 g/l, more preferably at least about 60 g/l, still more preferably at least about 70 g/l, yet more preferably at least about 80 g/l, even more preferably at least about 90 g/l, most preferably at least about 100 g/l, and in particular at least about 110 g/l.

Preferably, the fumed silica has a tamped density (ISO 787/11) of at most about 250 g/l, preferably at most about 225 g/l, more preferably at most about 200 g/l, still more preferably at most about 175 g/l, yet more preferably at most about 150 g/l, even more preferably at most about 100 g/l, most preferably at most about 80 g/l, and in particular at most about 60 g/l.

Preferably, the fumed silica has a tamped density (ISO 787/11) within the range of about 50±25 g/l, or 60±25 g/l, or 70±25 g/l, or 80±25 g/l, or 90±25 g/l, or 100±25 g/l, or 110±25 g/l, or 120±25 g/l, or 130±25 g/l, or 140±25 g/l, or 150±25 g/l.

In particularly preferred embodiments, the fumed silica has a tamped density (DIN EN ISO 787-11) within the range of about 50±20 g/l, preferably about 50±10 g/l, more preferably about 50±5.0 g/l.

In particularly preferred embodiments, the fumed silica has a density (DIN 51757) within the range of about 2.3±0.3 g/cm³, preferably about 2.3±0.2 g/cm³, more preferably about 2.3±0.1 g/cm³.

Preferably, the fumed silica has a dioctyl adipate absorption (ISO CD 19246) of at least about 200 ml/100 g, preferably at least about 210 ml/100 g, more preferably at least about 220 ml/100 g, still more preferably at least about 230 ml/100 g, yet more preferably at least about 240 ml/100 g, even more preferably at least about 250 ml/100 g, most preferably at least about 260 ml/100 g, and in particular at least about 270 ml/100 g.

Preferably, the fumed silica has a dioctyl adipate absorption (ISO CD 19246) of at most about 350 ml/100 g, preferably at most about 340 ml/100 g, more preferably at most about 330 ml/100 g, still more preferably at most about 320 ml/100 g, yet more preferably at most about 310 ml/100 g, even more preferably at most about 300 ml/100 g, most preferably at most about 290 ml/100 g, and in particular at most about 280 ml/100 g.

Preferably, the fumed silica has a dioctyl adipate absorption (ISO CD 19246) within the range of about 100±25 ml/100 g, or 125±25 ml/100 g, or 150±25 ml/100 g, or 175±25 ml/100 g, or 200±25 ml/100 g, or 225±25 ml/100 g, or 250±25 ml/100 g, or 275±25 ml/100 g, or 300±25 ml/100 g, or 325±25 ml/100 g, or 350±25 ml/100 g.

Preferably, the weight content of the fumed silica in the first component and/or in the second component independently from one another is at least about 0.04 wt.-%, preferably at least about 0.1 wt.-%; preferably at least about 0.3 wt.-%, preferably at least about 0.6 wt.-%, more preferably at least about 0.9 wt.-%, still more preferably at least about 1.2 wt.-%, yet more preferably at least about 1.5 wt.-%, even more preferably at least about 1.8 wt.-%, most preferably at least about 2.1 wt.-%, and in particular at least about 2.4 wt.-%; in each case relative to the total weight of the first component and of the second component, respectively.

Preferably, the weight content of the fumed silica in the first component and/or in the second component independently from one another is at most about 39 wt.-%, preferably at most about 37 wt. %, more preferably at most about 35 wt.-%, still more preferably at most about 33 wt.-%, yet more preferably at most about 31 wt.-%, even more preferably at most about 29 wt.-%, most preferably at most about 27 wt.-%, and in particular at most about 25 wt.-%; in each case relative to the total weight of the first component and of the second component, respectively.

Preferably, the weight content of the fumed silica in the first component and/or in the second component independently from one another is at most about 4.0 wt.-%, preferably at most about 3.5 wt. %, more preferably at most about 3.0 wt.-%, still more preferably at most about 2.5 wt.-%, yet more preferably at most about 2.0 wt.-%, even more preferably at most about 1.5 wt.-%, most preferably at most about 1.0 wt.-%, and in particular at most about 0.5 wt.-%; in each case relative to the total weight of the first component and of the second component, respectively; preferably the curable two-component system does not comprise fumed silica.

Preferably, the weight content of the fumed silica in the first component and/or in the second component independently from one another is within the range of from about 0.1 to 40 wt.-%, preferably from about 0.5 to 35 wt.-%, more preferably from about 10 to 30 wt.-%, still more preferably from about 2.5 to 25 wt.-%; in each case relative to the total weight of the first component and of the second component, respectively.

In preferred embodiments of the curable two-component system according to the invention,
the first component comprises a first portion of fumed silica; and
the second component comprises a second portion of fumed silica.

In preferred embodiments of the curable two-component system according to the invention, the second component is free of water.

In preferred embodiments of the curable two-component system according to the invention, the first component comprises water. Typically, the first component comprises moisture in amounts that are necessary to cure the entire mixture when both components of the two-component system are combined and mixed with one another.

Preferably, the weight content of water in the first component is at least about 0.05 wt.-%, preferably at least about 0.10 wt.-%, more preferably at least about 0.15 wt.-%, still more preferably at least about 0.20 wt.-%, yet more preferably at least about 0.25 wt.-%, even more preferably at least about 0.30 wt.-%, most preferably at least about 0.35 wt.-%, and in particular at least about 0.40 wt.-%; in each case relative to the total weight of the first component.

Preferably, the weight content of water in the first component is at least about 0.6 wt.-%, preferably at least about 0.8 wt.-%, more preferably at least about 1.0 wt.-%, still more preferably at least about 1.2 wt.-%, yet more preferably at least about 1.4 wt.-%, even more preferably at least about 1.6 wt.-%, most preferably at least about 1.8 wt.-%, and in particular at least about 2.0 wt.-%; in each case relative to the total weight of the first component.

Preferably, the weight content of water in the first component is at most about 7.0 wt.-%, preferably at most about 6.5 wt.-%, more preferably at most about 6.0 wt.-%, still more preferably at most about 5.5 wt.-%, yet more preferably at most about 5.0 wt.-%, even more preferably at most about 4.5 wt.-%, most preferably at most about 4.0 wt.-%, and in particular at most about 3.5 wt.-%; more preferably less than 3.0 wt.-%; still more preferably at most about 2.5 wt.-%; in each case relative to the total weight of the first component.

Preferably, the weight content of water in the first component is at most about 3.2 wt.-%, preferably at most about 3.0 wt.-%, more preferably at most about 2.8 wt.-%, still more preferably at most about 2.6 wt.-%, yet more preferably at most about 2.4 wt.-%, even more preferably at most about 2.2 wt.-%, most preferably at most about 2.0 wt.-%, and in particular at most about 1.8 wt.-%; more preferably less than 1.6 wt.-%; still more preferably at most about 1.4 wt.-%; in each case relative to the total weight of the first component.

Preferably, the weight content of water in the first component is within the range of from about 0.1 to 2.0 wt.-%, preferably from about 0.2 to 1.8 wt.-%, more preferably from about 0.3 to 1.6 wt.-%, still more preferably from about 0.4 to 1.4 wt.-%; in each case relative to the total weight of the first component.

Preferably, the weight content of water in the first component is within the range of from about 0.5 to 4.0 wt.-%, preferably from about 1.0 to 3.5 wt.-%, more preferably from about 1.5 to 3.0 wt.-%, still more preferably from about 1.8 to 2.8 wt.-%; in each case relative to the total weight of the first component.

Preferably, the stoichiometric ratio of water to humidity-curable prepolymers is at least 1.0, preferably at least 1.2, more preferably at least 1.4, still more preferably at least 1.6, yet more preferably at least 1.8, even more preferably at least 2.0, most preferably at least 2.2, and in particular at least 2.4; in each case relative to the total amount of humidity-curable prepolymers contained in the two-component system.

The curable two-component system according to the invention preferably comprises one or more curing catalysts. Preferably, the one or more curing catalysts are contained in the second component, whereas the first component is free of curing catalyst.

In preferred embodiments of the curable two-component system according to the invention, the first component is free of curing catalyst; in particular selected from
carboxylates of metals, preferably of tin, zinc, iron, lead, and cobalt; preferably selected from the group consisting of dibutyltin dilaurate (DBTDL), dibutyltin diacetate, dioctyltin dineodecanoate, dioctyltin dilaurate, stannous acetate, stannous caprylate, lead naphthenate, zinc caprylate, cobalt naphthenate;
organic bases; preferably selected from the group consisting of ethyl amines, dibutyl amine, hexylamines, and pyridine;
inorganic acids; preferably sulfuric acid or hydrochloric acid;
organic acids; preferably selected from the group consisting of toluene sulfonic acid, acetic acid, stearic acid and maleic acid; and
mixtures of any of the foregoing.

The prepolymer is humidity-curable, i.e. upon contact with humidity undergoes spontaneous curing, optionally also involving other ingredients that are contained in the composition such as curing agents. For the purpose of the specification, water is required for the humidity-curable prepolymer to undergo a curing reaction and is not a curing catalyst. A curing catalyst according to the invention increases the speed of the curing reaction of the two-component system, in particular of the one or more humidity-curable prepolymers. As far as water may be regarded as curing catalyst for the humidity-curable prepolymer, the first component preferably is free of curing catalyst other than water. Thus, the first component preferably does not comprise a curing catalyst in addition to water.

The curing catalyst according to the invention preferably is not water.

The curable two-component system according to the invention may comprise a single curing catalyst or a mixture of two or more curing catalysts. In case of the presence of two or more curing catalysts, all weights and percentages refer to the total weight of all curing catalysts that are contained in the curable two-component system. Curing catalysts for humidity-curable prepolymers such as silyl-modified prepolymers are known to the skilled person and commercially available.

In preferred embodiments of the curable two-component system according to the invention, the curing catalyst is selected from
carboxylates of metals, preferably of tin, zinc, iron, lead, and cobalt; preferably selected from the group consisting of dibutyltin dilaurate (DBTDL), dibutyltin diacetate, dioctyltin dineodecanoate, dioctyltin dilaurate, stannous acetate, stannous caprylate, lead naphthenate, zinc caprylate, cobalt naphthenate;
organic bases; preferably selected from the group consisting of ethyl amines, dibutyl amine, hexylamines, and pyridine;
inorganic acids; preferably sulfuric acid or hydrochloric acid;
organic acids; preferably selected from the group consisting of toluene sulfonic acid, acetic acid, stearic acid and maleic acid; and
mixtures of any of the foregoing.

Tin curing catalysts are particularly preferred such as dibutyltin dilaurate (DBTDL), dibutyltin diacetate, dioctyltin dineodecanoate, or dioctyltin dilaurate.

The curing catalyst according to the invention does not comprise water.

Preferably, the weight content of the curing catalyst in the second component is at least about 0.01 wt.-%, preferably at least about 0.02 wt.-%, more preferably at least about 0.03 wt.-%, still more preferably at least about 0.04 wt.-%, yet more preferably at least about 0.05 wt.-%, even more preferably at least about 0.06 wt.-%, most preferably at least about 0.07 wt.-%, and in particular at least about 0.08 wt.-%; in each case relative to the total weight of the second component.

Preferably, the weight content of the curing catalyst in the second component is at least about 0.10 wt.-%, preferably at least about 0.13 wt.-%, more preferably at least about 0.16 wt.-%, still more preferably at least about 0.19 wt.-%, yet more preferably at least about 0.21 wt.-%, even more preferably at least about 0.24 wt.-%, most preferably at least about 0.27 wt.-%, and in particular at least about 0.3 wt.-%; in each case relative to the total weight of the second component.

Preferably, the weight content of the curing catalyst in the second component is at most about 2.2 wt.-%, preferably at most about 2.1 wt.-%, more preferably at most about 2.0 wt.-%, still more preferably at most about 1.9 wt.-%, yet more preferably at most about 1.8 wt.-%, even more preferably at most about 1.7 wt.-%, most preferably at most about 1.6 wt.-%, and in particular at most about 1.5 wt.-%; in each case relative to the total weight of the second component.

Preferably, the weight content of the curing catalyst in the second component is within the range of from about 0.02 to 2.0 wt.-%, preferably from about 0.04 to 1.8 wt.-%, more preferably from about 0.06 to 1.6 wt.-%, still more preferably from about 0.08 to 1.4 wt.-%; in each case relative to the total weight of the second component.

Preferably, the weight content of the curing catalyst in the second component is within the range of from about 0.1 to 2.0 wt.-%, preferably from about 0.2 to 1.8 wt.-%, more preferably from about 0.3 to 1.6 wt.-%, still more preferably from about 0.4 to 1.4 wt.-%; in each case relative to the total weight of the second component.

In preferred embodiments of the curable two-component system according to the invention, the first component and/or the second component comprises a natural or synthetic silicate; preferably a layered silicate (phyllosilicate); more preferably selected from serpentine minerals, clay minerals, and mica minerals; still more preferably selected from talc, bentonite, montmorillonite, illite, pyrophyllite, and any combination thereof. Bentonite or talc is particularly preferred.

Preferably, the weight content of the silicate in the first component and/or in the second component independently from one another is at least about 10 wt.-%, preferably at least about 15 wt.-%, more preferably at least about 20 wt.-%, still more preferably at least about 25 wt.-%, yet more preferably at least about 30 wt.-%, even more preferably at least about 35 wt.-%, most preferably at least about 40 wt.-%, and in particular at least about 45 wt.-%; in each case relative to the total weight of the first component and of the second component, respectively.

Preferably, the weight content of the silicate in the first component and/or in the second component independently from one another is at most about 82 wt.-%, preferably at most about 79 wt.-%, more preferably at most about 76 wt.-%, still more preferably at most about 73 wt.-%, yet more preferably at most about 70 wt.-%, even more preferably at most about 67 wt.-%, most preferably at most about 64 wt.-%, and in particular at most about 61 wt.-%; more preferably less than 58 wt.-%; still more preferably at most about 55 wt.-%; in each case relative to the total weight of the first component and of the second component, respectively.

Preferably, the weight content of the silicate in the first component and/or in the second component independently from one another is at least about 0.04 wt.-%, preferably at least about 0.1 wt.-%; preferably at least about 0.3 wt.-%, preferably at least about 0.6 wt.-%, more preferably at least about 0.9 wt.-%, still more preferably at least about 1.2 wt.-%, yet more preferably at least about 1.5 wt.-%, even more preferably at least about 1.8 wt.-%, most preferably at least about 2.1 wt.-%, and in particular at least about 2.4 wt.-%; in each case relative to the total weight of the first component and of the second component, respectively.

Preferably, the weight content of the silicate in the first component and/or in the second component independently from one another is at most about 15 wt.-%, preferably at most about 14 wt.-%, more preferably at most about 13 wt.-%, still more preferably at most about 12 wt.-%, yet more preferably at most about 11 wt.-%, even more preferably at most about 10 wt.-%, most preferably at most about 9.0 wt.-%, and in particular at most about 8.0 wt.-%; more preferably less than 7.0 wt.-%; still more preferably at most about 6.0 wt.-%; in each case relative to the total weight of the first component and of the second component, respectively.

Preferably, the weight content of the silicate in the first component and/or in the second component independently from one another is within the range of from about 30 to 75 wt.-%, preferably from about 35 to 70 wt.-%, more preferably from about 40 to 65 wt.-%, still more preferably from about 45 to 60 wt.-%; in each case relative to the total weight of the first component and of the second component, respectively.

Preferably, the weight content of the silicate in the first component and/or in the second component independently from one another is within the range of from about 0.1 to 15 wt.-%, preferably from about 1.0 to 12 wt.-%, more preferably from about 2.0 to 10 wt.-%, still more preferably from about 2.5 to 6.0 wt.-%; in each case relative to the total weight of the first component and of the second component, respectively.

In preferred embodiments of the curable two-component system according to the invention,
the first component comprises a first portion of silicate; and
the second component comprises a second portion of silicate.

In preferred embodiments of the curable two-component system according to the invention, the first component and/or the second component comprises a graphene constituent; preferably graphene oxide, graphene, organo-modified graphene, or a mixture thereof. Graphene oxide is particularly preferred. Other graphene modifications, e.g. those achieved by plasma treatment, e.g. with NH₃, and other heteroatom modifications to manipulate the influence on pH are contemplated as well.

The curable two-component system according to the invention may comprise a single kind of graphene constituent or a mixture of two or more kinds of graphene constituents. In case of the presence of two or more kinds of graphene constituents, all weights and percentages refer to the total weight of all kinds of graphene constituents that are contained in the curable two-component system.

The graphene constituent can be single-layer, or multi-layer. Also, low degree of oxidation or no oxidation can be part of the two-component system.

Preferably, the weight content of the graphene constituent in the first component and/or in the second component independently from one another is at least about 0.04 wt.-%, preferably at least about 0.1 wt.-%; preferably at least about 0.3 wt.-%, preferably at least about 0.6 wt.-%, more preferably at least about 0.9 wt.-%, still more preferably at least about 1.2 wt.-%, yet more preferably at least about 1.5 wt.-%, even more preferably at least about 1.8 wt.-%, most preferably at least about 2.1 wt.-%, and in particular at least about 2.4 wt.-%; in each case relative to the total weight of the first component and of the second component, respectively.

Preferably, the weight content of the graphene constituent in the first component and/or in the second component independently from one another is at least about 5.0 wt.-%, preferably at least about 10 wt.-%, more preferably at least about 15 wt.-%, still more preferably at least about 25 wt.-%, yet more preferably at least about 30 wt.-%, even more preferably at least about 35 wt.-%, most preferably at least about 40 wt.-%, and in particular at least about 45 wt.-%; in each case relative to the total weight of the first component and of the second component, respectively.

Preferably, the weight content of the graphene constituent in the first component and/or in the second component independently from one another is at most about 60 wt.-%, preferably at most about 55 wt.-%, more preferably at most about 50 wt.-%, still more preferably at most about 45 wt.-%, yet more preferably at most about 40 wt.-%, even more preferably at most about 35 wt.-%, most preferably at most about 30 wt.-%, and in particular at most about 25 wt.-%; in each case relative to the total weight of the first component and of the second component, respectively.

Preferably, the weight content of the graphene constituent in the first component and/or in the second component independently from one another is at most about 20 wt.-%, preferably at most about 18 wt.-%, more preferably at most about 16 wt.-%, still more preferably at most about 14 wt.-%, yet more preferably at most about 12 wt.-%, even more preferably at most about 10 wt.-%, most preferably at most about 8.0 wt.-%, still more preferably from about 1.5 to 7.0 wt.-%, yet more preferably from about 2.5 to 6.0 wt.-%; in each case relative to the total weight of the first component and of the second component, respectively.

Preferably, the weight content of the graphene constituent in the first component and/or in the second component independently from one another is within the range of from about 0.1 to 15 wt.-%, preferably from about 0.5 to 10 wt.-%, more preferably from about 0.6 to 8.0 wt.-%, still more preferably from about 2.5 to 6.0 wt.-%; in each case relative to the total weight of the first component and of the second component, respectively.

In preferred embodiments of the curable two-component system according to the invention,
the first component comprises a first portion of graphene constituent; and
the second component comprises a second portion of graphene constituent.

Suitable graphene constituents are commercially available (e.g. NanoXplore 0X, NanoXplore 3X, HDPlas GNP-NH3).

In preferred embodiments of the curable two-component system according to the invention, the first component and/or the second component comprises carbon black.

Preferably, the carbon black has a Brunauer-Emmett-Teller (BET) surface area (nitrogen absorption, nitrogen surface area (NSA), ASTM D 6556) of at least about 50 m²/g, preferably at least about 60 m²/g, more preferably at least about 70 m²/g, still more preferably at least about 80 m²/g, yet more preferably at least about 90 m²/g, even more preferably at least about 100 m²/g, most preferably at least about 110 m²/g, and in particular at least about 120 m²/g.

Preferably, the carbon black has a Brunauer-Emmett-Teller (BET) surface area (nitrogen absorption, nitrogen surface area (NSA), ASTM D 6556) of at most about 220 m²/g, preferably at most about 210 m²/g, more preferably at most about 200 m²/g, still more preferably at most about 190 m²/g, yet more preferably at most about 180 m²/g, even more preferably at most about 170 m²/g, most preferably at most about 160 m²/g, and in particular at most about 150 m²/g.

Preferably, the carbon black has a Brunauer-Emmett-Teller (BET) surface area (nitrogen absorption, nitrogen surface area (NSA), ASTM D 6556) within the range of about 50±25 m²/g, or 60±25 m²/g, or 70±25 m²/g, or 80±25 m²/g, or 90±25 m²/g, or 100±25 m²/g, or 110±25 m²/g, or 120±25 m²/g, or 130±25 m²/g, or 140±25 m²/g, or 150±25 m²/g, or 160±25 m²/g; preferably within the range of from about 17 to 33 m²/g, or about 26 to 42 m²/g, or about 36 to 52 m²/g, or about 43 to 69 m²/g, or about 95 to 115 m²/g, or about 70 to 90 m²/g, or about 110 to 140 m²/g, or about 125 to 155 m²/g.

Preferably, the weight content of the carbon black in the first component and/or in the second component independently from one another is at least about 0.04 wt.-%; preferably at least about 0.1 wt.-%, preferably at least about 0.5 wt.-%, more preferably at least about 0.6 wt.-%, still more preferably at least about 1.0 wt.-%, yet more preferably at least about 1.1 wt.-%, even more preferably at least about 1.5 wt.-%, most preferably at least about 2.0 wt.-%, and in particular at least about 2.5 wt.-%; in each case relative to the total weight of the first component and of the second component, respectively.

Preferably, the weight content of the carbon black in the first component and/or in the second component independently from one another is at most about 15 wt.-%, preferably at most about 13 wt. %, more preferably at most about 12 wt.-%, still more preferably at most about 10 wt.-%, yet more preferably at most about 9 wt.-%, even more preferably at most about 8 wt.-%, most preferably at most about 7 wt.-%, and in particular at most about 6 wt.-%; in each case relative to the total weight of the first component and of the second component, respectively.

Preferably, the weight content of the carbon black in the first component and/or in the second component independently from one another is within the range of from about 0.1 to 15 wt.-%, preferably from about 0.5 to 10 wt.-%, more preferably from about 0.6 to 8.0 wt.-%, still more preferably from about 1.5 to 7.0 wt.-%, yet more preferably from about 2.5 to 6.0 wt.-%; in each case relative to the total weight of the first component and of the second component, respectively.

In preferred embodiments of the curable two-component system according to the invention, the first component and/or the second component comprises graphite; preferably expandable graphite.

Preferably, the weight content of the graphite in the first component and/or in the second component independently from one another is at least about 0.04 wt.-%; preferably at least about 0.1 wt.-%, preferably at least about 0.5 wt.-%, more preferably at least about 0.6 wt.-%, still more preferably at least about 1.0 wt.-%, yet more preferably at least about 1.1 wt.-%, even more preferably at least about 1.5 wt.-%, most preferably at least about 2.0 wt.-%, and in particular at least about 2.5 wt.-%; in each case relative to the total weight of the first component and of the second component, respectively.

Preferably, the weight content of the graphite in the first component and/or in the second component independently from one another is at most about 15 wt.-%, preferably at most about 13 wt.-%, more preferably at most about 12 wt.-%, still more preferably at most about 10 wt.-%, yet more preferably at most about 9 wt.-%, even more preferably at most about 8 wt.-%, most preferably at most about 7 wt.-%, and in particular at most about 6 wt.-%; in each case relative to the total weight of the first component and of the second component, respectively.

Preferably, the weight content of the graphite in the first component and/or in the second component independently from one another is within the range of from about 0.1 to 15 wt.-%, preferably from about 0.5 to 10 wt.-%, more preferably from about 0.6 to 8.0 wt.-%, still more preferably from about 1.5 to 7.0 wt.-%, yet more preferably from about 2.5 to 6.0 wt.-%; in each case relative to the total weight of the first component and of the second component, respectively.

In preferred embodiments of the curable two-component system according to the invention, the first component and/or the second component comprises a polycarbonate; preferably a polycarbonate diol.

The curable two-component system according to the invention may comprise a single polycarbonate or a mixture of two or more polycarbonates. In case of the presence of two or more polycarbonates, all weights and percentages refer to the total weight of all polycarbonates that are contained in the curable two-component system.

In preferred embodiments, the polycarbonate comprises or essentially consist of a polycarbonate polyol, preferably polycarbonate diol.

Polycarbonate polyols are preferably synthesized from CO₂ and epoxides. The CO₂ is sequestered in the backbone of a polycarbonate polyol by reaction with an epoxide during synthesis. Many different substituents can be used, to provide a broad range of polycarbonate polyol molecular structures:

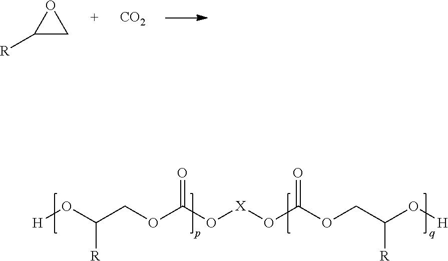

The functionality of a polycarbonate polyol can also be chosen as desired, by using any one of many different possible starting molecules X. For example, a diol or diacid as starting molecule X provides a polycarbonate diol, a triol or triacid as starting molecule X provides a polycarbonate triol, and a tetrol or tetraacid as starting molecule X provides a polycarbonate tetrol.

It has been surprisingly found that polycarbonate diols, i.e. polycarbonates derived from difunctional starting molecules X having terminal hydroxyl groups, provide a quick fixation after heating and recrystallizing as they can be liquids and crystalline solids.

Further, it has been surprisingly found that utilization of polycarbonates having various melting points allows for adjusting rheology like shear thinning, sag resistance, recovery and tailing for improved application properties in mass application environment requiring short handling times. It has been surprisingly found that polycarbonates, especially polycarbonate diols, further enhance multi-substrate adhesion, durability and high strength performance.

Preferably, the polycarbonate has general formula (III)

HO—R1-[O—C(═O)—O—R2]ₙ-OH (III);
wherein R1 and R2 are independently of one another selected from the group consisting of —C₁₋₁₂-alkylene-, —C₄₋₁₀-cycloalkylene-, —C₁₋₁₂-alkylene-C₄₋₁₀-cycloalkylene-C₁₋₁₂-alkylene-, —C₆₋₁₀-aryl-, —C₁₋₁₂-alkylene-C₆₋₁₀-aryl-C₁₋₁₂-alkylene-, —C₆₋₁₀-aryl-C₁₋₁₂-alkylene-C₆₋₁₀-aryl-, —[C₁₋₆-alkylene-O]ₘ—C₁₋₆-alkylene-, —[C₁₋₆-alkylene-O]ₘ—C₆₋₁₀-aryl-, —C(═O)—O—C₁₋₁₂-alkylene-, —C(═O)—O—C₁₋₆-alkylene-O—C₁₋₆-alkylene-, —C(═O)—O—C₆₋₁₀-aryl-, —C(═O)—O—C₁₋₆-alkylene-C₆₋₁₀-aryl-, —C(═O)—O—C₁₋₆-alkylene-O—C₆₋₁₀-aryl-; wherein m is an integer within the range of from 1 to 10; and
wherein n is an integer within the range of from 1 to 25, preferably 1, 2, 3, or 4.

In other preferred embodiments, the polycarbonate diol has general formula (IV)

H—[O—CHR1CH₂—O—C(═O)]p-O—X—O—[C(═O)—O—CH₂—CHR2-O]q-H (IV);
wherein
X is selected from the group consisting of —C₁₋₁₂-alkylene-, —C₄₋₁₀-cycloalkylene-, —C₁₋₁₂-alkylene-C₄₋₁₀-cycloalkylene-C₁₋₁₂-alkylene-, —C₆₋₁₀-aryl-, —C₁₋₁₂-alkylene-C₆₋₁₀-aryl-C₁₋₁₂-alkylene-, —C₆₋₁₀-aryl-C₁₋₁₂-alkylene-C₆₋₁₀-aryl-, —C(═O)—C₁₋₁₂-alkylene-C(═O)—, —C(═O)—C₄₋₁₀-cycloalkylene-C(═O)—, —C(═O)—C₁₋₁₂-alkylene-C₄₋₁₀-cycloalkylene-C₁₋₁₂-alkylene-C(═O)—, —C(═O)—C₆₋₁₀-aryl-C(═O)—, —C(═O)—C₁₋₁₂-alkylene-C₆₋₁₀-aryl-C₁₋₁₂-alkylene-C(═O)—, and —C(═O)—C₆₋₁₀-aryl-C₁₋₁₂-alkylene-C₆₋₁₀-aryl-C(═O)—;
R1 and R2 are independently of one another selected from the group consisting of —C₁₋₁₂-alkyl, —C₄₋₁₀-cycloalkyl, —C₁₋₂-alkylene-C₄₋₁₀-cycloalkyl, —C₆₋₁₀-aryl-, and —C₁₋₁₂-alkylene-C₆₋₁₀-aryl; and
p and q independently of one another are an integer within the range of from 1 to 25, preferably 1, 2, 3, or 4.

Preferably, the polycarbonate has a weight average molecular weight of at least about 500 g/mol, preferably at least about 530 g/mol, more preferably at least about 560 g/mol, still more preferably at least about 590 g/mol, yet more preferably at least about 620 g/mol, even more preferably at least about 650 g/mol, most preferably at least about 680 g/mol, and in particular at least about 710 g/mol, or at least about 1000 g/mol, or at least about 1500 g/mol.

Preferably, the polycarbonate has a weight average molecular weight of at most about 10000 g/mol, preferably at most about 9700 g/mol, more preferably at most about 9400 g/mol, still more preferably at most about 9100 g/mol, yet more preferably at most about 8800 g/mol, even more preferably at most about 8500 g/mol, most preferably at most about 8200 g/mol, and in particular at most about 7900 g/mol, or at most 6000 g/mol, or at most 4000 g/mol, or at most 3000 g/mol.

Preferably, the polycarbonate has a weight average molecular weight of from about 500 to 10000 g/mol; preferably within the range of about 1000±500 g/mol, or 1500±1000 g/mol, or 2000±1000 g/mol, or 2500±1000 g/mol, or 3000±1000 g/mol, or 3500±1000 g/mol, or 4000±1000 g/mol, or 4500±1000 g/mol, or 5000±1000 g/mol, or 5500±1000 g/mol, or 6000±1000 g/mol, or 6500±1000 g/mol, or 7000±1000 g/mol, or 7500±1000 g/mol, or 8000±1000 g/mol, or 8500±1000 g/mol, or 9000±1000 g/mol, or 9500±1000 g/mol, or 10000±1000 g/mol.

Preferably, the polycarbonate has a weight average molecular weight within the range of from about 500 to 10000 g/mol.

Preferably, the polycarbonate has a melting point of at least about −25 °C, preferably at least about −15 °C, more preferably at least about −5.0 °C, still more preferably at least about 5.0 °C, yet more preferably at least about 15 °C, even more preferably at least about 25 °C, most preferably at least about 35 °C, and in particular at least about 45 °C. Preferably, the polycarbonate has a melting point of at least about 0 °C, preferably at least about 10 °C, more preferably at least about 20 °C, still more preferably at least about 30 °C, yet more preferably at least about 40 °C, even more preferably at least about 50 °C, most preferably at least about 50 °C, and in particular at least about 60 °C.

Preferably, the polycarbonate has a melting point of at most about 200 °C, preferably at most about 190 °C, more preferably at most about 180 °C, still more preferably at most about 170 °C, yet more preferably at most about 1600 °C, even more preferably at most about 150 °C, most preferably at most about 140 °C, and in particular at most about 130 °C. Preferably, the polycarbonate has a melting point of at most about 120 °C, preferably at most about 115 °C, more preferably at most about 110 °C, still more preferably at most about 105 °C, yet more preferably at most about 100 °C, even more preferably at most about 95 °C, most preferably at most about 90 °C, and in particular at most about 85 °C.

Preferably, the polycarbonate has a melting point within the range of from about −20 to 120 °C.

Preferably, the weight content of the polycarbonate in the first component and/or in the second component independently from one another is at least about 0.5 wt.-%, preferably at least about 1.0 wt. %, more preferably at least about 1.5 wt.-%, still more preferably at least about 2.0 wt.-%, yet more preferably at least about 2.5 wt.-%, even more preferably at least about 3.0 wt.-%, most preferably at least about 3.5 wt.-%, and in particular at least about 4.0 wt.-%; in each case relative to the total weight of the first component and of the second component, respectively.

Preferably, the weight content of the polycarbonate in the first component and/or in the second component independently from one another is at most about 36 wt.-%, preferably at most about 33 wt. %, more preferably at most about 30 wt.-%, still more preferably at most about 27 wt.-%, yet more preferably at most about 24 wt.-%, even more preferably at most about 21 wt.-%, most preferably at most about 18 wt.-%, and in particular at most about 15 wt.-%; more preferably less than 12 wt.-%; still more preferably at most about 9.0 wt.-%; in each case relative to the total weight of the first component and of the second component, respectively.

Preferably, the weight content of the polycarbonate in the first component and/or in the second component independently from one another is within the range of from about 0.5 to 30 wt.-%, preferably from about 1.0 to 25 wt.-%, more preferably from about 2.5 to 15 wt.-%, still more preferably from about 5.0 to 10 wt.-%; in each case relative to the total weight of the first component and of the second component, respectively.

In preferred embodiments of the curable two-component system according to the invention,
the first component comprises a first portion of polycarbonate; and
the second component comprises a second portion of polycarbonate.

In preferred embodiments of the curable two-component system according to the invention, the first component and/or the second component comprises a plasticizer.

The curable two-component system according to the invention may comprise a single plasticizer or a mixture of two or more plasticizers. In case of the presence of two or more plasticizers, all weights and percentages refer to the total weight of all plasticizers that are contained in the curable two-component system.

Preferably, the plasticizer comprises or essentially consist of a copolymer polyol, preferably a copolymer of a polymeric material grafted onto a main polyol chain, more preferably a SAN (styrene/acrylonitrile) or an AN (acrylonitrile) grafted onto a polyether polyol or onto a polyester polyol.

In preferred embodiments, the plasticizer comprises or essentially consists of a SAN (styrene/acrylonitrile) grafted onto a polyol; preferably wherein the polyol is
a polyether polyol selected from polyoxymethylene, polyoxyethylene, polyoxypropylene, and polyoxybutylene; or
a polyester polyol, preferably an ester of a polyol of two to five carbon atoms and one or more aliphatic saturated organic acids.

Preferably, the copolymer polyol is selected from the group consisting of SAN-grafted polyether polyols and SAN-grafted polyester polyols; preferably SAN-grafted polyoxymethylene, SAN-grafted polyoxyethylene, SAN-grafted polyoxypropylene, and SAN-grafted polyoxybutylene.

Preferably, the plasticizer has a weight average molecular weight of at least about 100,000 g/mol, preferably at least about 120,000 g/mol, more preferably at least about 140,000 g/mol, still more preferably at least about 160,000 g/mol, yet more preferably at least about 180,000 g/mol, even more preferably at least about 200,000 g/mol, most preferably at least about 220,000 g/mol, and in particular at least about 240,000 g/mol.

Preferably, the plasticizer has a weight average molecular weight of at most about 500,000 g/mol, preferably at most about 480,000 g/mol, more preferably at most about 460,000 g/mol, still more preferably at most about 440,000 g/mol, yet more preferably at most about 420,000 g/mol, even more preferably at most about 400,000 g/mol, most preferably at most about 380,000 g/mol, and in particular at most about 360,000 g/mol.

Preferably, the plasticizer has a weight average molecular weight within the range of from about 100,000 to 500,000 g/mol.

Preferably, the polyol plasticizer has a weight average molecular weight within the range of from about 2,000 to 20,000 g/mol.

In preferred embodiments, the plasticizer comprises a polyol plasticizer; preferably wherein the polyol plasticizer is
selected from glycerol, sorbitol, ethylene glycol, diethylene glycol, triethylene glycol, tetraethylene glycol, polyethylene glycol, propylene glycol, dipropylene glycol, tripropylene glycol, tetrapropylene glycol, and polypropylene glycol; or
an esterified polyol plasticizer, preferably an ester of a polyol of two to five carbon atoms and one or more aliphatic saturated organic acids.

Preferably, the polyol plasticizer has a weight average molecular weight within the range of from about 2,000 to 20,000 g/mol.

In preferred embodiments, the plasticizer is selected from the group consisting of
phthalate plasticizers; preferably dioctyl terephthalate (DOTP), or diisononylphthalate (DINP);
1,2-cyclohexane dicarboxylic acid esters; preferably 1,2-cyclohexane dicarboxylic acid diisononyl ester (DINCH);
benzoates; preferably diethylene glycol dibenzoate (DE), or dipropylene glycol dibenzoate (DPGDB); and
bio-based plasticizers.

Preferably, the weight content of the plasticizer in the first component and/or in the second component independently from one another is at least about 1.0 wt.-%, preferably at least about 2.0 wt. %, more preferably at least about 3.0 wt.-%, still more preferably at least about 4.0 wt.-%, yet more preferably at least about 5.0 wt.-%, even more preferably at least about 6.0 wt.-%, most preferably at least about 7.0 wt.-%, and in particular at least about 8.0 wt.-%; in each case relative to the total weight of the first component and of the second component, respectively.

Preferably, the weight content of the plasticizer in the first component and/or in the second component independently from one another is at most about 60 wt.-%, preferably at most about 56 wt. %, more preferably at most about 52 wt.-%, still more preferably at most about 48 wt.-%, yet more preferably at most about 44 wt.-%, even more preferably at most about 40 wt.-%, most preferably at most about 36 wt.-%, and in particular at most about 32 wt.-%; more preferably less than 28 wt.-%; still more preferably at most about 24 wt.-%; in each case relative to the total weight of the first component and of the second component, respectively.

Preferably, the weight content of the plasticizer in the first component and/or in the second component independently from one another is within the range of from about 0.1 to 20 wt.-%, preferably from about 0.5 to 15 wt.-%, more preferably from about 1.0 to 10 wt.-%, still more preferably from about 1.5 to 5.0 wt.-%; in each case relative to the total weight of the first component and of the second component, respectively.

Preferably, the weight content of the plasticizer in the first component and/or in the second component independently from one another is within the range of from about 1.0 to 50 wt.-%, preferably from about 5.0 to 40 wt.-%, more preferably from about 7.5 to 30 wt.-%, still more preferably from about 10 to 25 wt.-%; in each case relative to the total weight of the first component and of the second component, respectively.

In preferred embodiments of the curable two-component system according to the invention,
the first component comprises a first portion of plasticizer; and
the second component comprises a second portion of plasticizer.

In preferred embodiments of the curable two-component system according to the invention, the first component and/or the second component, preferably the first component, comprises one or more alkoxy silanes.

Suitable alkoxy silanes include but are not limited to monoalkoxy trialkyl silanes, dialkoxy dialkyl silanes, trialkoxy monoalkyl silanes, and tetraalkoxy silanes.

Suitable alkoxy silanes include but are not limited to tetramethoxy silane, trimethoxy ethoxy silane, dimethoxy diethoxy silane, methoxy triethoxy silane, tetraethoxy silane, trimethoxy methyl silane, trimethoxy ethyl silane, trimethoxy propyl silane, dimethoxy dimethyl silane, dimethoxy diethyl silane, dimethoxy dipropyl silane, and the like.

In preferred embodiments, the one or more alkoxy silanes are selected from methoxy silanes.

In other preferred embodiments, the one or more alkoxy silanes are selected from ethoxy silanes.

It is also contemplated that the alkoxy silanes may be mixtures comprising methoxy silanes and ethoxy silanes and/or ethoxy methoxy silanes (i.e. difunctional silanes bearing methoxy as well as ethoxy groups).

Preferred alkoxy silanes according to the invention include but are not limited to hexadecyl trimethoxysilane, methyl triethoxy silane (MTES), methyl trimethoxy silane (MTMS), octyl triethoxy silane (OCTEO), octyl trimethoxy silane (OCTMO), propyl triethoxy silane (PTEO), and propyl trimethoxy silane (PTMO). PTMO is particularly preferred.

Certain alkoxy silanes may also act as silane compatibilizer which typically bear at least one non-hydrolyzable functional group such as vinyl or amino. For the purpose of the specification, such silane compatibilizers are distinguished from the above alkoxy silanes. The alkoxy silanes according to the invention are preferably composed of substituents selected from alkyl groups and alkoxy groups but do not additionally have non-hydrolyzable functional groups.

Preferably, the weight content of the one or more alkoxy silanes in the first component and/or in the second component independently from one another is at least about 0.1 wt.-%, preferably at least about 0.2 wt.-%, more preferably at least about 0.3 wt.-%, still more preferably at least about 0.4 wt. %, yet more preferably at least about 0.5 wt.-%, even more preferably at least about 0.6 wt.-%, most preferably at least about 0.7 wt.-%, and in particular at least about 0.8 wt.-%; in each case relative to the total weight of the first component and of the second component, respectively.

Preferably, the weight content of the one or more alkoxy silanes in the first component and/or in the second component independently from one another is at most about 5.1 wt.-%, preferably at most about 4.8 wt.-%, more preferably at most about 4.5 wt.-%, still more preferably at most about 4.2 wt. %, yet more preferably at most about 3.9 wt.-%, even more preferably at most about 3.6 wt.-%, most preferably at most about 3.3 wt.-%, and in particular at most about 3.0 wt.-%; more preferably less than 2.7 wt.-%; still more preferably at most about 2.4 wt.-%; in each case relative to the total weight of the first component and of the second component, respectively.

Preferably, the weight content of the one or more alkoxy silanes in the first component and/or in the second component independently from one another is within the range of from about 0.2 to 5.0 wt.-%, preferably from about 0.3 to 4.0 wt.-%, more preferably from about 0.4 to 3.0 wt.-%, still more preferably from about 0.5 to 2.5 wt.-%; in each case relative to the total weight of the first component and of the second component, respectively.

In preferred embodiments of the curable two-component system according to the invention, the first component and/or the second component comprises a silane compatibilizer; preferably a functional silane.

The curable two-component system according to the invention may comprise a single silane compatibilizer or a mixture of two or more silane compatibilizers. In case of the presence of two or more silane compatibilizers, all weights and percentages refer to the total weight of all silane compatibilizers that are contained in the curable two-component system. Silane compatibilizers are known to the skilled person and commercially available.

In preferred embodiments, the silane compatibilizer is
an amino silane, preferably a diamino-functional silane or a multifunctional aminosilane, more preferably N-2-aminoethyl-3-aminopropyltrimethoxysilane (DAMO); or a bifunctional silane possessing a reactive primary amino group and hydrolyzable ethoxysilyl groups, more preferably 3-aminopropyltriethoxysilane (AMEO);
a vinyl silane, preferably a bifunctional organosilane possessing a vinyl group and a hydrolyzable trimethoxysilyl group (VTMO) or a bifunctional organosilane possessing a vinyl group and a hydrolyzable 2-methoxy-ethoxy-silyl group (VTMOEO); or
a mixture thereof.

Trimethoxy(vinyl)silane (VTMO) is a particularly preferred silane compatibilizer and additionally may act as moisture scavenger.

N-2-aminoethyl-3-aminopropyltrimethoxysilane (DAMO) is another particularly preferred silane compatibilizer.

In preferred embodiments, the curable two-component system according to the invention contains as silane compatibilizer a combination of trimethoxy(vinyl)silane (VTMO) and N-2-aminoethyl-3-aminopropyltrimethoxysilane (DAMO).

Preferably, the silane compatibilizer comprises a hydrolyzable group and a nonhydrolyzable group.

Preferably, the hydrolyzable group is a hydrolyzable silyl group as defined as above with regard to the silyl-modified prepolymer.

Preferably, the nonhydrolyzable group is selected from —C₁₋₁₂-alkyl, —CH═CH₂, —NH₂, —NHC₁₋₁₂-alkyl, and —N(C₁₋₁₂-alkyl)₂.

Preferably, the weight content of the silane compatibilizer in the first component and/or in the second component independently from one another is at least about 0.1 wt.-%, preferably at least about 0.2 wt.-%, more preferably at least about 0.3 wt.-%, still more preferably at least about 0.4 wt.-%, yet more preferably at least about 0.5 wt.-%, even more preferably at least about 0.6 wt.-%, most preferably at least about 0.7 wt.-%, and in particular at least about 0.8 wt.-%; in each case relative to the total weight of the first component and of the second component, respectively.

Preferably, the weight content of the silane compatibilizer in the first component and/or in the second component independently from one another is at most about 5.1 wt.-%, preferably at most about 4.8 wt.-%, more preferably at most about 4.5 wt.-%, still more preferably at most about 4.2 wt.-%, yet more preferably at most about 3.9 wt.-%, even more preferably at most about 3.6 wt.-%, most preferably at most about 3.3 wt.-%, and in particular at most about 3.0 wt.-%; more preferably less than 2.7 wt.-%; still more preferably at most about 2.4 wt.-%; in each case relative to the total weight of the first component and of the second component, respectively.

Preferably, the weight content of the silane compatibilizer in the first component and/or in the second component independently from one another is within the range of from about 0.2 to 5.0 wt.-%, preferably from about 0.3 to 4.0 wt.-%, more preferably from about 0.4 to 3.0 wt.-%, still more preferably from about 0.5 to 2.5 wt.-%; in each case relative to the total weight of the first component and of the second component, respectively.

In preferred embodiments of the curable two-component system according to the invention,
the first component comprises a first portion of silane compatibilizer; and
the second component comprises a second portion of silane compatibilizer.

In preferred embodiments of the curable two-component system according to the invention, the first component and/or the second component, preferably the first component, comprises one or more buffers (pH buffers).

Buffers can be used to control the pH value and include but are not limited to
TAPS ([tris(hydroxymethyl)methylamino]propanesulfonic acid);
Bicine (2-(bis(2-hydroxyethyl)amino)acetic acid);
Tris (tris(hydroxymethyl)aminomethane;
Tricine (N-[tris(hydroxymethyl)methyl]glycine);
TAPSO (3-[N-tris(hydroxymethyl)methylamino]-2-hydroxypropanesulfonic acid);
HEPES (4-(2-hydroxyethyl)-1-piperazineethanesulfonic acid);
TES (2-[[1,3-dihydroxy-2-(hydroxymethyl)propan-2-yl]amino]ethanesulfonic acid);
MOPS (3-(N-morpholino)propanesulfonic acid);
PIPES (piperazine-N,N′-bis(2-ethanesulfonic acid));
Cacodylate (dimethylarsenic acid); and
MES (2-(N-morpholino)ethanesulfonic acid).

In preferred embodiments of the curable two-component system according to the invention, dissolving or suspending 10 g of the first component in 100 mL pure water at 23 °C provides a solution or suspension having a pH value determined according to ASTM D1293A of at least about 7.5; preferably at least about 8.0, more preferably at least about 8.5, still more preferably at least about 9.0, yet more preferably at least about 9.5, even more preferably at least about 10.0, most preferably at least about 10.5, and in particular at least about 11.0.

In preferred embodiments, the pH value is within the range of from about 7.5 to 9.5.

In preferred embodiments, the pH value is within the range of from about 5.0 to 11, preferably from about 6.0 to 11, more preferably from about 6.5 to 10.5, still more preferably from about 7.0 to 10, and yet more preferably from about 7.5 to 9.5.

In preferred embodiments, the pH value is within the range of from about 5.0 to 10, preferably from about 6.0 to 10, more preferably from about 6.5 to 10, still more preferably from about 7.0 to 10, and yet more preferably from about 7.5 to 9.5.

Preferably, the pH value is at most about 14.0; preferably at most about 13.5, more preferably at most about 13.0, still more preferably at most about 12.5, yet more preferably at most about 12.0, even more preferably at most about 11.5, most preferably at most about 11.0, and in particular at most about 10.5.

It has been surprisingly found that Na⁺-ions stabilize silane-modified prepolymers in the presence of water (curative) at elevated pH value. When Na⁺-ions are present, the pH value for the first component is preferably at least 5, more preferably at least 7. When Na⁺-ions are present, the pH value for the first component is preferably at least 9. When no Na⁺-ions are present, the pH value for the first component is preferably at least 10.

In preferred embodiments of the curable two-component system according to the invention, dissolving or suspending 10 g of the second component in 100 mL pure water at 23 °C provides a solution or suspension having a pH value determined according to ASTM D1293A of at most about 6.5; preferably at most about 6.0, more preferably at most about 5.5, still more preferably at most about 5.0, yet more preferably at most about 4.5, even more preferably at most about 4.0, most preferably at most about 3.5, and in particular at most about 3.0.

Preferably, the pH value is at least about 1.0; preferably at least about 1.5, more preferably at least about 2.0, still more preferably at least about 2.5, yet more preferably at least about 3.0, even more preferably at least about 3.5, most preferably at least about 4.0, and in particular at least about 4.5.

It has been surprisingly found that various properties of a two-component system can be manipulated by the combination of pH value, presence and amount of Na⁺-ions and/or K⁺-ions, presence and amount of metal oxides that are capable of forming stable silanol complexes, presence and amount of metal catalysts, and presence and amount of amine catalysts. The properties that can be manipulated include but are not limited to curing kinetics, latency, open time, strength build-up and shelf-life.

In preferred embodiments of the curable two-component system according to the invention, dissolving or suspending 10 g of the first component in 100 mL pure water at 23 °C provides a solution or suspension having an ionic strength of at least about 0.2 mol·L⁻¹; preferably at least about 0.4 mol-L⁻¹, more preferably at least about 0.6 mol·L⁻¹, still more preferably at least about 0.8 mol·L⁻¹, yet more preferably at least about 1.0 mol·L⁻¹, even more preferably at least about 1.2 mol·L⁻¹, most preferably at least about 1.4 mol·L⁻¹, and in particular at least about 1.6 mol·L⁻¹.

Preferably, the ionic strength is at most about 3.4 mol·L⁻¹; preferably at most about 3.2 mol·L⁻¹, more preferably at most about 3.0 mol·L⁻¹, still more preferably at most about 2.8 mol·L⁻¹, yet more preferably at most about 2.6 mol·L⁻¹, even more preferably at most about 2.4 mol·L⁻¹, most preferably at most about 2.2 mol·L⁻¹, and in particular at most about 2.0 mol·L⁻¹.

In preferred embodiments of the curable two-component system according to the invention, dissolving or suspending 10 g of the first component in 100 mm pure water at 23 °C provides a solution or suspension having an electrical conductivity determined according to ASTM D 1125A of at least about 1.0 mS·cm⁻¹; preferably at least about 2.5 mS·cm⁻¹, more preferably at least about 5.0 mS·cm⁻¹, still more preferably at least about 7.5 mS·cm⁻¹, yet more preferably at least about 10 mS·cm⁻¹, even more preferably at least about 15 mS·cm⁻¹, most preferably at least about 20 mS·cm⁻¹, and in particular at least about 25 mS·cm⁻¹.

Preferably, the electrical conductivity is at most about 125 mS·cm⁻¹; preferably at most about 100 mS·cm⁻¹, more preferably at most about 90 mS·cm⁻¹, still more preferably at most about 80 mS·cm⁻¹, yet more preferably at most about 70 mS·cm⁻¹, even more preferably at most about 60 mS·cm⁻¹, most preferably at most about 50 mS·cm⁻¹, and in particular at most about 40 mS·cm⁻¹.

In preferred embodiments of the curable two-component system according to the invention, the ratio V₁:V₂ of the volume of the first component V₁ to the volume of the second component V₂ is within the range of from 20:1 to 1:20; preferably 15:1 to 1:15, more preferably 10:1 to 1:10, still more preferably 7.5:1 to 1:7.5, yet more preferably 5:1 to 1:5, even more preferably 4:1 to 1:4, most preferably 3:1 to 1:3, and in particular 2:1 to 1:2. Preferably, the ratio V₁:V₂ of the volume of the first component V₁ to the volume of the second component V₂ is 1:1, 1:2, 1:3 or 1:4 (v/v).

In preferred embodiments of the curable two-component system according to the invention, the first component and/or the second component comprises one or more additives selected from the group consisting of curing accelerators, adhesion promoters, antioxidants, stabilizers, colorants, pigments, fillers, toughening agents, impact modifiers, flame retardants, blowing agents, and moisture scavengers.

Preferably, the adhesion promoter is selected from the group consisting of glycidoxypropyltrimethoxy silane, aminoethyl-aminopropyl-trimethoxy silane, aminopropyltriethoxy silane, hydrolyzed aminoethyl-aminopropylmethyldimethoxy silane, aminopropyltrimethoxy silane, and mixtures thereof.

Preferably, the antioxidant is a 3-(3,5-di-tert-butyl-4-hydroxyphenyl)propionic acid ester, e.g. the methyl ester, the octyl ester (Irganox® 1135), the octadecyl ester (Irganox® 1076, or the pentaerythrityl ester (Irganox® 1010)), the latter being particularly preferred (pentaerythritol tetrakis[3-[3,5-di-tert-butyl-4-hydroxyphenyl]propionate).

Preferably, the filler is calcium carbonate which may be untreated or treated e.g. with stearic acid. Other suitable fillers include but are not limited to one or more mineral or stone type fillers such as sodium carbonate or magnesium carbonate.

Preferably, the flame retardant is triethyl phosphate.

Preferably, the moisture scavenger is selected from vinyltrimethoxy silane, phenyltrimethoxy silane, and mixtures thereof.

In preferred embodiments of the curable two-component system according to the invention, the first component and/or the second component independently of one another has a Brookfield viscosity (ASTM D789, D4878) at least about 50,000 mPa·s, preferably at least about 75,000 mPa·s, more preferably at least about 100,000 mPa·s, still more preferably at least about 125,000 mPa·s, yet more preferably at least about 150,000 mPa·s, even more preferably at least about 175,000 mPa·s, most preferably at least about 200,000 mPa·s and in particular at least about 250,000 mPa·s; preferably when the first component and/or the second component is freshly prepared and/or after 10 days at 50 °C.

In preferred embodiments of the curable two-component system according to the invention, the first component and/or the second component independently of one another has a Brookfield viscosity of at most about 700,000 mPa·s, preferably at most about 650,000 mPa·s, more preferably at most about 600,000 mPa·s, still more preferably at most about 550,000 mPa·s, yet more preferably at most about 500,000 mPa·s, even more preferably at most about 450,000 mPa·s, most preferably at most about 400,000 mPa·s and in particular at most about 350,000 mPa·s; preferably when the first component and/or the second component is freshly prepared and/or after 10 days at 50 °C.

Preferably, the first component and/or the second component independently of one another has a Brookfield viscosity (ASTM D789, D4878) of at most about 600,000 mPa·s, preferably at most about 500,000 mPa·s, more preferably at most about 400,000 mPa·s; preferably when the first component and/or the second component is freshly prepared and/or after 10 days at 50 °C.

Preferably, the first component and/or the second component independently of one another has a Brookfield viscosity (ASTM D789, D4878) within the range from about 50,000 to 600,000 mPa·s, preferably from about 75,000 to 500,000 mPa·s, more preferably from about 100,000 to 400,000 mPa·s; preferably when the first component and/or the second component is freshly prepared and/or after 10 days at 50 °C.

In preferred embodiments, the curable two-component system according to the invention has a storage stability at 23 °C of at least about 1 month, preferably at least about 2 months, more preferably at least about 3 months, still more preferably at least about 4 months, yet more preferably at least about 5 months, even more preferably at least about 6 months, most preferably at least about 9 months, and in particular at least about 1 year.

In preferred embodiments, the curable two-component system according to the invention is fast curing.

In preferred embodiments of the curable two-component system according to the invention, a fresh prepared mixture of the first component and the second component has an open time within the range of from about 5.0 to 60 minutes. Preferably, the open time is determined by means of a spatula in contact to the curing composition (mixture). When no material of the curing composition is transferred to the spatula anymore, this is defined as the open time. Typically, the spatula is made from wood.

Preferably, a fresh prepared mixture of the first component and the second component has an open time of
at least about 5 minutes, preferably within the range of from about 5 to 60 minutes; or
at least about 20 minutes, preferably within the range of from about 20 to 60 minutes, more preferably about 20 to 40 minutes.

In preferred embodiments of the curable two-component system according to the invention, a fresh prepared mixture of the first component and the second component has a handling time to reach a lap shear strength of 0.5 MPa determined according to DIN 53504:2017-03 within the range of from about 0.5 to 8 hours.

Preferably, a fresh prepared mixture of the first component and the second component has a handling time to reach a lap shear strength of 0.5 MPa determined according to DIN 53504:2017-03 of
at least about 30 minutes, preferably within the range of from 0.5 to 2 hours; these embodiments are particularly preferred for applications in automotive industries; or
at least about 2 hours, preferably within the range of from 4 to 8 hours; these embodiments are particularly preferred for applications in automotive, rail or bus industries as well as for fenestration.

In preferred embodiments, the curable two-component system according to the invention is polyurethane free.

In preferred embodiments, the curable two-component system according to the invention does not contain phthalate plasticizers, preferably no phthalate at all.

In preferred embodiments of the curable two-component system according to the invention
the weight content of the one or more donors for Na⁺ ions (Na-donors), preferably Na₂O, NaOH, or a mixture thereof, in the first component is at least about 0.03 wt.-%, preferably at least about 0.04 wt.-%; and
dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the one or more basic inorganic fillers or anhydrides thereof; preferably one or more metal hydroxides, and/or one or more metal oxides and/or anhydrides of metal hydroxides, and/or one or more nitrides, preferably covalent nitrides; more preferably selected from Al(OH)₃, MgO, ZnO, Al₂O₃, BN, AlN, and any mixture thereof; and dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the graphene constituent; and dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the natural or synthetic silicate; preferably a layered silicate; more preferably selected from talc, bentonite, montmorillonite, illite, pyrophyllite, or any combination thereof; still more preferably talc or bentonite; and dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises carbon black; and dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises expandable graphite; and dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the one or more basic inorganic fillers or anhydrides thereof; preferably one or more metal hydroxides, and/or one or more metal oxides and/or anhydrides of metal hydroxides, and/or one or more nitrides, preferably covalent nitrides; more preferably selected from Al(OH)₃, MgO, ZnO, Al₂O₃, BN, AlN, and any mixture thereof; and the weight content of the one or more donors for Na⁺ ions (Na-donors), preferably Na₂O, NaOH, or a mixture thereof, in the first component is at least about 0.03 wt.-%, preferably at least about 0.04 wt.-%.

In preferred embodiments, the curable two-component system according to the invention comprises the graphene constituent; and the weight content of the one or more donors for Na⁺ ions (Na-donors), preferably Na₂O, NaOH, or a mixture thereof, in the first component is at least about 0.03 wt.-%, preferably at least about 0.04 wt.-%.

In preferred embodiments, the curable two-component system according to the invention comprises the natural or synthetic silicate; preferably a layered silicate; more preferably selected from talc, bentonite, montmorillonite, illite, pyrophyllite, or any combination thereof; still more preferably talc or bentonite; and the weight content of the one or more donors for Na⁺ ions (Na-donors), preferably Na₂O, NaOH, or a mixture thereof, in the first component is at least about 0.03 wt.-%, preferably at least about 0.04 wt.-%.

In preferred embodiments, the curable two-component system according to the invention comprises carbon black; and the weight content of the one or more donors for Na⁺ ions (Na-donors), preferably Na₂O, NaOH, or a mixture thereof, in the first component is at least about 0.03 wt.-%, preferably at least about 0.04 wt.-%.

In preferred embodiments, the curable two-component system according to the invention comprises expandable graphite; and the weight content of the one or more donors for Na⁺ ions (Na-donors), preferably Na₂O, NaOH, or a mixture thereof, in the first component is at least about 0.03 wt.-%, preferably at least about 0.04 wt.-%.

In preferred embodiments, the curable two-component system according to the invention comprises the one or more basic inorganic fillers or anhydrides thereof; preferably one or more metal hydroxides, and/or one or more metal oxides and/or anhydrides of metal hydroxides, and/or one or more nitrides, preferably covalent nitrides; more preferably selected from Al(OH)₃, MgO, ZnO, Al₂O₃, BN, AlN, and any mixture thereof;
wherein
   the weight content of the one or more donors for Na⁺ ions (Na-donors), preferably Na₂O, NaOH, or a mixture thereof, in the first component is at least about 0.03 wt.-%, preferably at least about 0.04 wt.-%; and
   dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the graphene constituent;
wherein
   the weight content of the one or more donors for Na⁺ ions (Na-donors), preferably Na₂O, NaOH, or a mixture thereof, in the first component is at least about 0.03 wt.-%, preferably at least about 0.04 wt.-%; and
   dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the natural or synthetic silicate; preferably a layered silicate; more preferably selected from talc, bentonite, montmorillonite, illite, pyrophyllite, or any combination thereof; still more preferably talc or bentonite;
wherein
   the weight content of the one or more donors for Na⁺ ions (Na-donors), preferably Na₂O, NaOH, or a mixture thereof, in the first component is at least about 0.03 wt.-%, preferably at least about 0.04 wt.-%; and
   dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises carbon black;
wherein
   the weight content of the one or more donors for Na⁺ ions (Na-donors), preferably Na₂O, NaOH, or a mixture thereof, in the first component is at least about 0.03 wt.-%, preferably at least about 0.04 wt.-%; and
   dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises expandable graphite;
wherein
   the weight content of the one or more donors for Na⁺ ions (Na-donors), preferably Na₂O, NaOH, or a mixture thereof, in the first component is at least about 0.03 wt.-%, preferably at least about 0.04 wt.-%; and
   dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the graphene constituent and additionally one or more of
the one or more basic inorganic fillers or anhydrides thereof;
the natural or synthetic silicate;
carbon black; and
expandable graphite.

In preferred embodiments, the curable two-component system according to the invention comprises the graphene constituent and additionally one or more of
the one or more basic inorganic fillers or anhydrides thereof;
the natural or synthetic silicate;
carbon black; and
expandable graphite;
   and wherein
dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the graphene constituent and additionally the one or more basic inorganic fillers or anhydrides thereof; preferably one or more metal hydroxides, and/or one or more metal oxides and/or anhydrides of metal hydroxides, and/or one or more nitrides, preferably covalent nitrides; more preferably selected from Al(OH)₃, MgO, ZnO, Al₂O₃, BN, AlN, and any mixture thereof; and dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the graphene constituent and additionally the natural or synthetic silicate; preferably a layered silicate; more preferably selected from talc, bentonite, montmorillonite, illite, pyrophyllite, or any combination thereof; still more preferably talc or bentonite; and dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the graphene constituent and additionally carbon black; and dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the graphene constituent and additionally expandable graphite; and dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the graphene constituent and additionally one or more of
the one or more basic inorganic fillers or anhydrides thereof;
the natural or synthetic silicate;
carbon black; and
expandable graphite;
   and wherein
the weight content of the one or more donors for Na⁺ ions (Na-donors), preferably Na₂O, NaOH, or a mixture thereof, in the first component is at least about 0.03 wt.-%, preferably at least about 0.04 wt.-%.

In preferred embodiments, the curable two-component system according to the invention comprises the graphene constituent and additionally the one or more basic inorganic fillers or anhydrides thereof; preferably one or more metal hydroxides, and/or one or more metal oxides and/or anhydrides of metal hydroxides, and/or one or more nitrides, preferably covalent nitrides; more preferably selected from Al(OH)₃, MgO, ZnO, Al₂O₃, BN, AlN, and any mixture thereof; and the weight content of the one or more donors for Na⁺ ions (Na-donors), preferably Na₂O, NaOH, or a mixture thereof, in the first component is at least about 0.03 wt.-%, preferably at least about 0.04 wt.-%.

In preferred embodiments, the curable two-component system according to the invention comprises the graphene constituent and additionally the natural or synthetic silicate; preferably a layered silicate; more preferably selected from talc, bentonite, montmorillonite, illite, pyrophyllite, or any combination thereof; still more preferably talc or bentonite; and the weight content of the one or more donors for Na⁺ ions (Na-donors), preferably Na₂O, NaOH, or a mixture thereof, in the first component is at least about 0.03 wt.-%, preferably at least about 0.04 wt.-%.

In preferred embodiments, the curable two-component system according to the invention comprises the graphene constituent and additionally carbon black; and the weight content of the one or more donors for Na⁺ ions (Na-donors), preferably Na₂O, NaOH, or a mixture thereof, in the first component is at least about 0.03 wt.-%, preferably at least about 0.04 wt.-%.

In preferred embodiments, the curable two-component system according to the invention comprises the graphene constituent and additionally expandable graphite; and the weight content of the one or more donors for Na⁺ ions (Na-donors), preferably Na₂O, NaOH, or a mixture thereof, in the first component is at least about 0.03 wt.-%, preferably at least about 0.04 wt.-%.

In preferred embodiments, the curable two-component system according to the invention comprises the graphene constituent and additionally one or more of
the one or more basic inorganic fillers or anhydrides thereof;
the natural or synthetic silicate;
carbon black; and
expandable graphite;
   and wherein
the weight content of the one or more donors for Na⁺ ions (Na-donors), preferably Na₂O, NaOH, or a mixture thereof, in the first component is at least about 0.03 wt.-%, preferably at least about 0.04 wt.-%; and
dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the graphene constituent and additionally the one or more basic inorganic fillers or anhydrides thereof; preferably one or more metal hydroxides, and/or one or more metal oxides and/or anhydrides of metal hydroxides, and/or one or more nitrides, preferably covalent nitrides; more preferably selected from Al(OH)₃, MgO, ZnO, Al₂O₃, BN, AlN, and any mixture thereof;
and
   the weight content of the one or more donors for Na⁺ ions (Na-donors), preferably Na₂O, NaOH, or a mixture thereof, in the first component is at least about 0.03 wt.-%, preferably at least about 0.04 wt.-%; and
   dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the graphene constituent and additionally the natural or synthetic silicate; preferably a layered silicate; more preferably selected from talc, bentonite, montmorillonite, illite, pyrophyllite, or any combination thereof; still more preferably talc or bentonite;
and
   the weight content of the one or more donors for Na⁺ ions (Na-donors), preferably Na₂O, NaOH, or a mixture thereof, in the first component is at least about 0.03 wt.-%, preferably at least about 0.04 wt.-%; and
   dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the graphene constituent and additionally carbon black;
and
   the weight content of the one or more donors for Na⁺ ions (Na-donors), preferably Na₂O, NaOH, or a mixture thereof, in the first component is at least about 0.03 wt.-%, preferably at least about 0.04 wt.-%; and
   dissolving or suspending 10 g of the first component in 100 mL pure water at 23 °C provides a solution or suspension having a pH value determined according to ASTM D1293A within the range of from about 5.0 to 10, preferably about 7 to 10.

In preferred embodiments, the curable two-component system according to the invention comprises the graphene constituent and additionally expandable graphite;
and
   the weight content of the one or more donors for Na⁺ ions (Na-donors), preferably Na₂O, NaOH, or a mixture thereof, in the first component is at least about 0.03 wt.-%, preferably at least about 0.04 wt.-%; and
   dissolving or suspending 10 g of the first component in 100 mL pure water at 23 °C provides a solution or suspension having a pH value determined according to ASTM D1293A within the range of from about 5.0 to 10, preferably about 7 to 10.

Another aspect of the invention relates to a cured composition obtainable by mixing the first component and the second component of the curable two-component system according to the invention as described above and curing the thus obtained mixture.

In preferred embodiments, the cured composition according to the invention has a slip resistance determined in accordance with ISO 10545-17 of at least about 0.1, preferably at least about 0.2, more preferably at least about 0.3, still more preferably at least about 0.5, yet more preferably at least about 0.6, even more preferably at least about 0.7, most preferably at least about 0.8, and in particular at least about 0.9.

In preferred embodiments, the cured composition according to the invention has a slip resistance determined by using a lap shear test set up, in a vertical arrangement, with a weight applied to the lower substrate and measuring displacement over time within the range from about 0 to 2 mm.

In preferred embodiments, the cured composition according to the invention has a G modulus determined according to DIN EN 1465 of at least about 1.0 MPa, preferably within the range from about 1.0 to 3.5 MPa.

In preferred embodiments, the cured composition according to the invention has a G-modulus determined according to DIN EN 1465
of at least about 1.0 MPa, preferably within the range from about 1.0 to 2.0 MPa; or
of at least about 1.5 MPa, preferably within the range from about 1.5 to 3.5 MPa.

In preferred embodiments, the cured composition according to the invention has an energy impact absorption determined in accordance with FMVSS212 crash worthiness (front screen) of at least about 1 Joule, preferably at least about 2 Joule, more preferably at least about 3 Joule.

In preferred embodiments, the cured composition according to the invention has an elongation determined according to DIN EN 1465 of
at least about 200%, preferably within the range of from about 250 to 300%; or
at least 400%.

In preferred embodiments, the cured composition according to the invention has a tensile strength determined according to EN ISO DIN 53504:2017-03 of at least about 2.0 MPa, preferably at least about 3.0 MPa, more preferably at least about 4.5 MPa.

In preferred embodiments, the cured composition according to the invention has an electrical conductivity determined according to ASTM D257-14 within the range from about 1·10⁻⁸ Ω·cm to about 1·10⁻¹¹ Ω·cm.

Another aspect of the invention relates to a container comprising the curable two-component system according to the invention as described above, wherein the first component is spatially separated from the second component. Suitable containers include cartridges and foil bags. Suitable containers further include dual cartridge systems comprising two storage containers, which preferably have a volume ratio of 1:1, 1:2, 1:3 or 1:4 (v/v).

Another aspect of the invention relates to the use of a curable two-component system according to the invention as described above as a sealant and/or an adhesive.

Preferably, the curable two-component system according to the invention is used for fenestration.

Preferably, the curable two-component system according to the invention is used in the production of a vehicle selected from the group consisting of automobiles, railway vehicles, and commercial vehicles.

For applications in rail industry, the curable two-component system according to the invention preferably provides
a high slip resistance for sealing heavy screens,
open time in the range of from about 20 to 40 minutes,
handling time to reach a lap shear strength of 0.5 MPa determined according to DIN 53504:2017-03 within the range of from about 4 to 8 hours,
a G modulus determined according to ASTM D3983 within the range of from about 1.0 to 2.0 MPa,
elongation determined according to ASTM D897 of greater than 400%, and
a tensile strength determined according to ASTM D897 of greater than 4.5 MPa.

For applications in bus industry the curable two-component system according to the invention preferably provides
a high slip resistance for sealing heavy screens,
open time in the range of from about 20 to 60 minutes,
handling time to reach a lap shear strength of 0.5 MPa determined according to DIN 53504:2017-03 within the range of from about 4 to 8 hours,
energy impact absorption of about 3 Joule for FMVSS212 crash worthiness (front screen),
a G modulus determined according to ASTM D3983 within the range of from about 1.0 to 2.0 MPa,
elongation determined according to ASTM D897 within the range of from about 250 to 300%, and
a tensile strength determined according to ASTM D897 of greater than 4.5 MPa.

For applications in automotive industry, the curable two-component system according to the invention preferably provides
a high slip resistance for sealing lighter screens,
open time in the range of from about 5 to 20 minutes,
handling time to reach a lap shear strength of 0.5 MPa determined according to DIN 53504:2017-03 within the range of from about 0.5 to 2 hours,
energy impact absorption of about 3 Joule for FMVSS212 crash worthiness (front screen),
a G modulus determined according to ASTM D3983 within the range of from about 1.5 to 3.5 MPa,
elongation determined according to ASTM D897 within the range of from about 250 to 300%, and
a tensile strength determined according to ASTM D897 of greater than 4.5 MPa.

For applications in fenestration, the curable two-component system according to the invention preferably provides
a high slip resistance for sealing lighter screens,
open time in the range of from about 5 to 20 minutes,
handling time to reach a lap shear strength of 0.5 MPa determined according to DIN 53504:2017-03 within the range of from about 4 to 8 hours, and
electrical nonconductivity, i.e. resistivity.

Another aspect of the invention relates to a method of bonding a first substrate to a second substrate comprising the steps of
(a) mixing the first component and the second component of a curable two-component system according to the invention as described above;
(b) contacting a surface of the first substrate and a surface of the second substrate with the mixture obtained in step (a); and
(c) allowing the mixture to cure.

Preferably, the first substrate and/or the second substrate is glass.

Another aspect of the invention relates to a method of sealing a contact area of a first substrate and a second substrate comprising the steps of
(a) mixing the first component and the second component of a curable two-component system according to the invention as described above;
(b) contacting a surface of the first substrate and a surface of the second substrate with the mixture obtained in step (a); and
(c) allowing the mixture to cure.

Preferably, the first substrate and/or the second substrate is glass.

Particularly preferred curable two-component systems according to the invention contain the following components in the following quantities (first component: embodiments A1 to A4; second component: embodiments B1 to B4):

| [wt.-%] | A1 | A2 | A3 | A4 |
|---|---|---|---|---|
| water curative | 0.1 to 2.0 | 0.2 to 1.8 | 0.3 to 1.6 | 0.4 to 1.4 |
| silyl-modified | 10 to 90 | 20 to 80 | 30 to 70 | 35 to 55 |
| prepolymer, preferably | | | | |
| polyether | | | | |
| Na-donor, preferably | 0.05 to 3.0 | 0.5 to 2.4 | 0.8 to 2.1 | 1.1 to 1.9 |
| Na₂O and/or NaOH | | | | |
| K-donor, preferably K₂O | 0.05 to 3.0 | 0.5 to 2.4 | 0.8 to 2.1 | 1.1 to 1.9 |
| and/or KOH | | | | |
| Al(OH)₃ | 0.1 to 15 | 1.0 to 12 | 2.0 to 10 | 2.5 to 6.0 |
| MgO | 0.1 to 15 | 1.0 to 12 | 2.0 to 10 | 2.5 to 6.0 |
| ZnO | 0.1 to 15 | 1.0 to 12 | 2.0 to 10 | 2.5 to 6.0 |
| Al₂O₃ | 0.1 to 15 | 1.0 to 12 | 2.0 to 10 | 2.5 to 6.0 |
| SiO₂ | 0.1 to 15 | 1.0 to 12 | 2.0 to 10 | 2.5 to 6.0 |
| fumed silica | 0.1 to 40 | 0.5 to 35 | 1.0 to 30 | 2.5 to 25 |
| layered silicate, | 0.1 to 15 | 1.0 to 12 | 2.0 to 10 | 2.5 to 6.0 |
| preferably bentonite | | | | |
| graphene oxide | 0.1 to 15 | 0.5 to 10 | 0.6 to 8.0 | 2.5 to 6.0 |
| polycarbonate diol | 0.5 to 30 | 1.0 to 25 | 2.5 to 15 | 5.0 to 10 |
| SAN-grafted onto polyol | 1.0 to 50 | 5.0 to 40 | 7.5 to 30 | 10 to 25 |
| silane compatibilizer and/ | 0.2 to 5.0 | 0.3 to 4.0 | 0.4 to 3.0 | 0.5 to 2.5 |
| or alkoxy silane | | | | |

| [wt.-%] | B1 | B2 | B3 | B4 |
|---|---|---|---|---|
| curing catalyst | 0 to 2.0 | 0.1 to 2.0 | 0.2 to 1.5 | 0.3 to 1.5 |
| silyl-modified | 5 to 90 | 10 to 80 | 15 to 70 | 25 to 55 |
| prepolymer, preferably | | | | |
| polyether | | | | |
| Na-donor, preferably | 0.05 to 3.0 | 0.5 to 2.4 | 0.8 to 2.1 | 1.1 to 1.9 |
| Na₂O and/or NaOH | | | | |
| K-donor, preferably K₂O | 0.05 to 3.0 | 0.5 to 2.4 | 0.8 to 2.1 | 1.1 to 1.9 |
| and/or KOH | | | | |
| Al(OH)₃ | 0.1 to 15 | 1.0 to 12 | 2.0 to 10 | 2.5 to 6.0 |
| MgO | 0.1 to 15 | 1.0 to 12 | 2.0 to 10 | 2.5 to 6.0 |
| ZnO | 0.1 to 15 | 1.0 to 12 | 2.0 to 10 | 2.5 to 6.0 |
| Al₂O₃ | 0.1 to 15 | 1.0 to 12 | 2.0 to 10 | 2.5 to 6.0 |
| SiO₂ | 0.1 to 15 | 1.0 to 12 | 2.0 to 10 | 2.5 to 6.0 |
| fumed silica | 0.1 to 40 | 0.5 to 35 | 1.0 to 30 | 2.5 to 25 |
| layered silicate, | 0.1 to 15 | 1.0 to 12 | 2.0 to 10 | 2.5 to 6.0 |
| preferably bentonite | | | | |
| graphene oxide | 0.1 to 15 | 0.5 to 10 | 0.6 to 8.0 | 2.5 to 6.0 |
| polycarbonate diol | 0.5 to 30 | 1.0 to 25 | 2.5 to 15 | 5.0 to 10 |
| SAN-grafted onto polyol | 1.0 to 50 | 5.0 to 40 | 7.5 to 30 | 10 to 25 |
| silane compatibilizer and/ | 0.2 to 5.0 | 0.3 to 4.0 | 0.4 to 3.0 | 0.5 to 2.5 |
| or alkoxy silane | | | | |

Particularly preferred curable two-component systems according to the invention contain the following components in the following quantities (first component: embodiments A5 to A6; second component: embodiments B5 to B36):

| [wt.-%] | A5 | A6 |
|---|---|---|
| water | 0.4 to 2.8 | 1.8 to 2.8 |
| silyl-modified prepolymer, preferably polyether | 25 to 70 | 25 to 60 |
| Na-donor, preferably Na₂O and/or NaOH | 0.03 to 0.5 | 0.04 to 0.10 |
| BN | 0.1 to 15 | 0.1 to 15 |
| Al(OH)₃ | 15 to 60 | 45 to 60 |
| graphene | 2.5 to 10 | 2.5 to 6.0 |
| expandable graphite | 2.5 to 6.0 | 2.5 to 6.0 |
| carbon black | 0.1 to 15 | 0.1 to 15 |
| polyol plasticizer | 0.1 to 15 | 0.1 to 15 |

| [wt.-%] | B5 | B6 |
|---|---|---|
| curing catalyst | 0 to 2.0 | 0.05 to 2.0 |
| silyl-modified prepolymer, preferably polyether | 25 to 70 | 25 to 60 |
| Na-donor, preferably Na₂O and/or NaOH | 0.03 to 0.5 | 0.04 to 0.10 |
| BN | 0.1 to 15 | 0.1 to 15 |
| Al(OH)₃ | 15 to 60 | 35 to 55 |
| graphene | 2.5 to 10 | 2.5 to 6.0 |
| carbon black | 0.1 to 15 | 0.1 to 15 |
| expandable graphite | 2.5 to 6.0 | 2.5 to 6.0 |
| silane compatibilizer and/or alkoxy silane | 0.2 to 5.0 | 0.3 to 4.0 |
| antioxidant | 0.1 to 15 | 0.1 to 15 |

The following examples further illustrate the invention but are not to be construed as limiting its scope.

### EXAMPLE 1

Compositions comprising 30 g silyl-modified prepolymer, 4 g graphene, 0.4 g water and 10 g filler with different contents of Na₂O (donor for Na⁺ ions) and different pH values were manufactured by blending all ingredients with one another. The stability of the compositions was determined after storage at 40 °C for 1 to 2 weeks.

The results as well as type of filler, pH value and content of Na₂O are compiled in the table here below:

| | | | filler/additive | pH | Na₂O [ppm] | stability |
|---|---|---|---|---|---|---|
| 1-1 | | graphene | graphene | 4 | 200 | not ok |
| 1-2 | | constituent | graphene | 7 | 400 | ok |
| 1-3 | | | graphene | 7 | 400 | ok |
| 1-4 | | | graphene | 7 | 400 | ok |
| 1-5 | | | graphene oxide | 2 | 400 | not ok |
| 1-6 | | | NH₃-modif. graphene | 10 | 400 | ok |
| 1-7 | basic | metal | Al₂O₃ | 5 | 400 | ok |
| 1-8 | inorganic | oxides | Al₂O₃ | 8 | 400 | ok |
| 1-9 | filler | | Al₂O₃ | 8 | 150 | not ok |
| 1-10 | | | Al₂O₃ | 8 | 700 | ok |
| 1-11 | | metal | Al(OH)₃ | 8 | 100 | not ok |
| 1-12 | | hydroxides | Al(OH)₃ | 7 | 750 | ok |
| 1-13 | | | Al(OH)₃ | 8 | 100 | not ok |
| 1-14 | | | NaOH | 11 | 700 | not ok |
| 1-15 | | | carbon black | 7 | <200 | not ok |
| 1-16 | | | expandable graphite | 7 | 300 | borderline |
| 1-17 | | | aluminum nitride | 8.5 | 400 | ok |
| 1-18 | filler | silicate | Na-bentonite | 8 | >>700 | ok |

As demonstrated by the above comparative data, the pH value and content of Na₂O (donor for Na⁺ ions) are relevant for the stability of the compositions. Compositions with pH values of less than 5 or more than 11 resulted in gelled products after storage at 40 °C for 1 to 2 weeks. Further, compositions with Na₂O (donor for Na⁺ ions) content of less than 400 ppm (0.04 wt.-%) resulted in gelled products after storage at 40 °C for 1 to 2 weeks. Thus, compositions were stable with a pH value within the range of 5 to 10, in particular 7 to 10, and/or a weight content of Na₂O (donor for Na⁺ ions) of at least 0.04 wt.-%, relative to the total weight of the composition (first component). As further demonstrated by the above comparative data, graphene constituents, basic inorganic fillers such as metal oxides and metal hydroxides, in particular Al₂O₃ and Al(OH)₃, expandable graphite, aluminum nitride, and silicates such as Na-bentonite are suitable fillers/additives for stable compositions.

### EXAMPLE 2

Compositions comprising 30 g silyl-modified prepolymer, 4 g graphene, 0.4 g water and 10 g filler with different pH values were manufactured by blending all ingredients with one another. The stability of the compositions was determined after storage at 40 °C for 1 to 2 weeks.

The results as well as type of filler, pH value and content of Na₂O are compiled in the table here below:

| | filler/additive | pH | Na₂O [ppm] | stability |
|---|---|---|---|---|
| 2-1 | ZnO | 7 | — | ok |
| 2-2 | MgO | 10 | — | ok |
| 2-3 | Mg₃Si₄O₁₀(OH)₂ (talc) | 8 | — | ok |

As demonstrated by the above data, filler/additives such as ZnO, MgO and Mg₃Si₄O₁₀(OH)₂ (talc) can stabilize the compositions. All compositions 2-1 to 2-3 were stable after storage at 40 °C for 1 to 2 weeks.

### EXAMPLE 3

Compositions comprising 30 g silyl-modified prepolymer, 4 g graphene, 0.4 g water and 10 g Al₂O₃ with 700 ppm Na₂O (donor for Na⁺ ions) and a pH value of 8 were manufactured by blending all ingredients with one another. The stability of the compositions was determined after storage at 40 °C for 1 to 2 weeks.

The results as well as type of humidity-curable prepolymer are compiled in the table here below:

| | | | | Na₂O | |
|---|---|---|---|---|---|
| | prepolymer | filler | pH | [ppm] | stability |
| 3-1 | silyl-modified prepolymer | Al₂O₃ | 8 | 700 | ok |
| 3-2 | silyl-modified polyether | Al₂O₃ | 8 | 700 | ok |
| 3-3 | silyl-modified polyether | Al₂O₃ | 8 | 700 | ok |
| 3-4 | silyl-modified polyether | Al₂O₃ | 8 | 700 | ok |
| | (α-silane terminated polyether) | | | | |

As demonstrated by the above data, all compositions 3-1 to 3-4 with different humidity-curable prepolymers were stable after storage at 40 °C for 1 to 2 weeks.

### EXAMPLE 4

Compositions comprising 30 g silyl-modified prepolymer, 0.4 g water and 10 g filler with different contents of Na₂O (donor for Na⁺ ions) and different pH values were manufactured by blending all ingredients with one another. The stability of the compositions was determined after storage at 40 °C for 1 to 2 weeks.

The results as well as type of filler, pH value and content of Na₂O are compiled in the table here below:

| | filler | pH | Na₂O [ppm] | stability |
|---|---|---|---|---|
| 4-1 | Al₂O₃ | 8 | 400 | ok |
| 4-2 | Al(OH)₃ | 7 | 700 | ok |

As demonstrated by the above data, compositions 3-1 and 3-2 comprising Al₂O₃ and Al(OH)₃ with a weight content of Na₂O (donor for Na⁺ ions) of at least 400 ppm (0.04 wt.-%, relative to the total weight of the composition) and a pH value of 7 or 8 were stable after storage at 40 °C for 1 to 2 weeks.

### EXAMPLE 5

The following compositions were manufactured by blending the ingredients of each component with one another and determining the viscosity directly after blending and after 10 days at 50 °C. The first composition 5-1 had a content of Na₂O (donor for Na⁺ ions) of at least 400 ppm, while the first composition 5-2 had a content of Na₂O (donor for Na⁺ ions) of less than 400 ppm:

| | | first component | |
|---|---|---|---|
| | | 5-1 | 5-2 |
| | second | Na₂O [ppm] | |
| [wt.-%] | component | >400 | <400 |
| silyl-modified prepolymer | 21.87 | | |
| silyl-modified prepolymer | 14.58 | | |
| silyl-modified prepolymer | | 32.00 | 32.00 |
| polyol | | 1.50 | 1.50 |
| boron nitride | 2.50 | 1.00 | 1.00 |
| antioxidant | 0.46 | | |
| Al(OH)₃ | 37.50 | 21.70 | |
| Al(OH)₃ | 10.00 | 33.00 | 54.70 |
| graphene | 3.05 | 3.00 | |
| graphene | | | 3.00 |
| carbon black | 1.50 | 1.50 | 1.50 |
| expandable graphite | 4.00 | 4.00 | 4.00 |
| silane compatibilizer (DAMO) | 0.99 | | |
| amino silane | 0.47 | | |
| silane compatibilizer (VTMO) | 3.00 | | |
| dioctyltin dineodecanoate | 0.08 | | |
| water | | 2.30 | 2.30 |
| total | 100.00 | 100.00 | 100.00 |
| viscosity fresh | 338 Pa · s | 327 Pa · s | 683 Pa · s |
| stability after 10 days @50 °C | ok | ok | not okay |
| per viscosity | 423 Pa · s | 333 Pa · s | (cured) |
| | | | ∞ Pa · s |

As demonstrated by the above comparative data, the first composition 5-1 with a weight content of Na₂O (donor for Na⁺ ions) of at least 400 ppm (0.04 wt.-%, relative to the total weight of the first component) was stable after 10 days at 50 °C, while the first composition 5-2 with a weight content of Na₂O (donor for Na⁺ ions) of less than 400 ppm was not stable, i.e. cured after 10 days at 50 °C. Thus, a content of Na₂O (donor for Na⁺ ions) of at least 400 ppm can stabilize the first component.

1. A curable two-component system comprising or essentially consisting of
(a) a first component comprising
one or more humidity-curable prepolymers;
optionally, water; and
one or more of the following:
one or more basic inorganic fillers or anhydrides thereof;
a graphene constituent;
a natural or synthetic silicate;
carbon black;
expandable graphite;
wherein the first component is free of curing catalyst; and
(b) a second component optionally comprising one or more curing catalysts;
preferably wherein the first component comprises
one or more humidity-curable prepolymers;
one or more basic inorganic fillers or anhydrides thereof; and
optionally, water.

2-4. (canceled)

5. The curable two-component system according to claim 1, wherein the one or more humidity-curable prepolymers comprise or essentially consist of one or more silyl-modified prepolymers.

6-14. (canceled)

15. The curable two-component system according to claim 1, wherein the humidity-curable prepolymer comprises a polymeric backbone selected from the group consisting of polyethers, copolyethers, polyurethanes, copolyurethanes, polyesters, copolyesters, polyamides, copolyamids, polyolefins, copolyolefins, polystyrenes, copolystyrenes, polyacrylates, copolyacrylates, and mixtures thereof; preferably polyethers or copolyethers.

16. (canceled)

17. The curable two-component system according to claim 1, wherein the humidity-curable prepolymer is selected from the group consisting of dimethoxy-silyl-terminated polyether or copolyether, trimethoxy-silyl-terminated polyether or copolyether, dimethoxy-silyl-terminated polyether or copolyether in each case reinforced with silicone moieties, trimethoxy-silyl-terminated polyether or copolyether in each case reinforced with silicone moieties, hydrophobically modified dimethoxy-silyl-terminated polyether or copolyether, monofunctional dimethoxy-silyl-terminated polyether or copolyether, and monofunctional trimethoxy-silyl-terminated polyether or copolyether.

18-32. (canceled)

33. The curable two-component system according to claim 5, wherein the one or more basic inorganic fillers or anhydrides thereof comprise or essentially consist of
one or more metal hydroxides; preferably selected from NaOH, KOH, Ca(OH)₂, Mg(OH)₂, Zn(OH)₂, Cu(OH)₂, Al(OH)₃, and any mixture thereof; more preferably selected from Ca(OH)₂, Mg(OH)₂, Zn(OH)₂, Cu(OH)₂, Al(OH)₃, and any mixture thereof; still more preferably Al(OH)₃;
one or more metal oxides and/or anhydrides of metal hydroxides; preferably selected from Na₂O, K₂O, CaO, MgO, ZnO, CuO, Al₂O₃, and any mixture thereof; more preferably selected from CaO, MgO, ZnO, CuO, Al₂O₃, and any mixture thereof; still more preferably MgO, ZnO, Al₂O₃, and any mixture thereof;
one or more nitrides, preferably covalent nitrides; more preferably selected from BN, AlN, GaN, InN, Cu₃N, and any mixture thereof; still more preferably BN, AlN, and any mixture thereof; or
any mixture thereof.

34-40. (canceled)

41. The curable two-component system according to claim 33, wherein the first component and/or the second component, preferably the first component, comprises one or more donors for Na⁺ ions (Na-donors); preferably independently from one another selected from Na₂O, NaOH, and a mixture thereof; more preferably Na₂O.

42-51. (canceled)

52. The curable two-component system according to claim 33, wherein the first component and/or the second component, preferably the first component, comprises one or more donors for K⁺ ions (K-donors); preferably independently from one another selected from K₂O, KOH, and a mixture thereof.

53-83. (canceled)

84. The curable two-component system according to claim 52, wherein the first component and/or the second component, preferably the first component, comprises SiO₂; preferably other than fumed silica (pyrogenic silica); more preferably selected from the group consisting of precipitated silica, fused silica, colloidal silica, silica gel, silica aerogel, and silica xerogel.

85-108. (canceled)

109. The curable two-component system according to claim 1, wherein the first component comprises water; preferably the first component comprises moisture in amounts that are necessary to cure the entire mixture when both components of the two-component system are combined and mixed with one another.

110. (canceled)

111. The curable two-component system according to claim 109, wherein the weight content of water in the first component is at least about 0.6 wt.-%, preferably at least about 0.8 wt.-%, more preferably at least about 1.0 wt.-%, still more preferably at least about 1.2 wt.-%, yet more preferably at least about 1.4 wt.-%, even more preferably at least about 1.6 wt.-%, most preferably at least about 1.8 wt.-%, and in particular at least about 2.0 wt.-%; in each case relative to the total weight of the first component.

112-115. (canceled)

116. The curable two-component system according to claim 1, wherein the stoichiometric ratio of water to humidity-curable prepolymers is at least 1.0, preferably at least 1.2, more preferably at least 1.4, still more preferably at least 1.6, yet more preferably at least 1.8, even more preferably at least 2.0, most preferably at least 2.2, and in particular at least 2.4; in each case relative to the total amount of humidity-curable prepolymers contained in the two-component system.

117. The curable two-component system according to claim 116, wherein the curing catalyst is selected from
carboxylates of metals, preferably of tin, zinc, iron, lead, and cobalt; preferably selected from the group consisting of dibutyltin dilaurate (DBTDL), dibutyltin diacetate, dioctyltin dineodecanoate, dioctyltin dilaurate, stannous acetate, stannous caprylate, lead naphthenate, zinc caprylate, cobalt naphthenate;
organic bases; preferably selected from the group consisting of ethyl amines, dibutyl amine, hexylamines, and pyridine;
inorganic acids; preferably sulfuric acid or hydrochloric acid;
organic acids; preferably selected from the group consisting of toluene sulfonic acid, acetic acid, stearic acid and maleic acid; and mixtures of any of the foregoing.

118-123. (canceled)

124. The curable two-component system according to claim 1, wherein the first component and/or the second component comprises a natural or synthetic silicate; preferably a layered silicate; more preferably selected from talc, bentonite, montmorillonite, illite, pyrophyllite, or any combination thereof; still more preferably talc or bentonite.

125-130. (canceled)

131. The curable two-component system according to claim 1, wherein the first component and/or the second component comprises a graphene constituent; preferably graphene oxide, graphene, organo-modified graphene, or a mixture thereof.

132-134. (canceled)

135. The curable two-component system according to claim 1, wherein the first component and/or the second component comprises carbon black.

136-142. (canceled)

143. The curable two-component system according to claim 1, wherein the first component and/or the second component comprises a polycarbonate; preferably a polycarbonate diol.

144-153. (canceled)

154. The curable two-component system according to claim 5 wherein the first component and/or the second component comprises a plasticizer.

155-167. (canceled)

168. The curable two-component system according to claim 1, wherein the first component and/or the second component comprises
a silane compatibilizer; preferably a functional silane; and/or
an alkoxy silane; preferably a non-functional silane.

169-186. (canceled)

187. The curable two-component system according to claim 1, wherein the first component and/or the second component comprises one or more additives selected from the group consisting of curing accelerators, adhesion promoters, stabilizers, colorants, pigments, fillers, toughening agents, impact modifiers, blowing agents, and moisture scavengers.

188-193. (canceled)

194. The curable two-component system according to claim 1, wherein a fresh prepared mixture of the first component and the second component has an open time within the range of from about 5.0 to 60 minutes.

195-228. (canceled)
